(19) United States
(12) Patent Application Publication
(10) Pub. No.: US 2021/0324555 A1
(43) Pub. Date: Oct. 21, 2021

(54) SHEET MANUFACTURING APPARATUS AND CONTROL METHOD OF SHEET MANUFACTURING APPARATUS

(71) Applicant: SEIKO EPSON CORPORATION, Tokyo (JP)

(72) Inventors: Kaneo YODA, Okaya, Nagano (JP); Yoshiyuki NAGAI, Shiojiri, Nagano (JP); Yuki OGUCHI, Okaya, Nagano (JP); Shigeo FUJITA, Matsumoto, Nagano (JP); Akira ARAI, Suwa-gun, Shimosuwa-machi, Nagano (JP); Kazuhiro ICHIKAWA, Okaya, Nagano (JP); Teruaki OGUCHI, Suwa, Nagano (JP); Seiichi TANIGUCHI, Higashichikuma-gun, Asahi-mura, Nagano (JP)

(21) Appl. No.: 16/497,500

(22) PCT Filed: Mar. 1, 2018
(86) PCT No.: PCT/JP2018/007750

§ 371 Date: Sep. 25, 2019

(30) Foreign Application Priority Data
Mar. 27, 2017 (JP) 2017-060603

(51) Int. Cl. D04H 1/60; D04H 1/732; D04H 1/736; D21B 1/06

(52) U.S. Cl. CPC D04H 1/60; D21B 1/06; D04H 1/736; D04H 1/732

(57) ABSTRACT

A sheet manufacturing apparatus includes a defibrating portion that defibrates a raw material, a mixing portion that mixes a defibrated material defibrated by the defibrating portion, a heating portion that heats a mixture mixed by the mixing portion, and a control portion that controls a temperature of the heating portion, in which the control portion sets a heating temperature of the heating portion to a temperature depending on a type of the raw material defibrated by the defibrating portion.

### CROSS-REFERENCE TO RELATED APPLICATIONS

This application is a U.S. National stage application of International Patent Application No. PCT/JP2018/007750, filed on Mar. 1, 2018, which claims priority under 35 U.S.C. § 119(a) to Japanese Patent Application No. 2017-060603, filed in Japan on Mar. 27, 2017. The entire disclosure of Japanese Patent Application No. 2017-060603 is hereby incorporated herein in its entirety by reference.

### TECHNICAL FIELD

The present invention relates to a sheet manufacturing apparatus and a control method of the sheet manufacturing apparatus.

### BACKGROUND ART

In general, in a sheet manufacturing apparatus, an apparatus having a heating portion for heating a material is known (for example, refer to Japanese Unexamined Patent Application Publication No. 2016-130009). The sheet manufacturing apparatus described in Japanese Unexamined Patent Application Publication No. 2016-130009 forms a sheet by heating a material containing fibers and a resin.

A quality of the sheet manufactured by the sheet manufacturing apparatus is influenced by a nature of the material and treatment conditions such as heating of the material. Therefore, although it was desirable to set appropriate conditions, it was not easy for a user to judge the appropriate conditions by himself. In addition, if the set conditions are not appropriate, the quality of the manufactured sheet may be degraded.

An object of the present invention is to make it possible to appropriately set conditions for manufacturing a sheet in a sheet manufacturing apparatus and to manufacture a high quality sheet.

### SUMMARY

In order to solve the above problems, in the above-described configuration, the present invention includes a defibrating portion that defibrates a raw material, a mixing portion that mixes a defibrated material defibrated by the defibrating portion with a binding material, a heating portion that heats a mixture mixed by the mixing portion, and a control portion that controls a temperature of the heating portion, in which the control portion sets a heating temperature of the heating portion to a temperature depending on a type of the raw material defibrated by the defibrating portion.

According to the present invention, the heating temperature when the raw material is defibrated and the defibrated material and the binding material are mixed and heated is set to a temperature depending on the type of the raw material. As a result, the heating temperature can be appropriately set as a condition for manufacturing a sheet in the sheet manufacturing apparatus, and a high quality sheet can be manufactured.

In addition, in the above-described configuration, the apparatus may further include a binding material supply portion that individually contains different types of the binding materials and supplies the binding material to the mixing portion, in which the control portion may select at least one type of the binding material from a plurality of types of the binding materials depending on the type of the raw material defibrated by the defibrating portion, and may cause the selected binding material to be supplied by the binding material supply portion.

According to the configuration, since the binding material suitable for the raw material from different types of the binding materials can be selected and used, a higher quality sheet can be manufactured.

In addition, in order to solve the above problems, the present invention includes a defibrating portion that defibrates a raw material, a binding material supply portion that individually contains different types of the binding materials and supplies the binding material, a mixing portion that mixes a defibrated material defibrated by the defibrating portion with the binding material supplied by the binding material supply portion, a heating portion that heats a mixture mixed by the mixing portion, and a control portion that selects the binding material to be supplied to the mixing portion and causes the binding material to be supplied by the binding material supply portion, in which the control portion selects at least one type of the binding material among a plurality of types of the binding materials depending on a type of the raw material defibrated by the defibrating portion and causes the selected binding material to be supplied by the binding material supply portion.

According to the present invention, when manufacturing the sheet by defibrating the raw material, mixing the defibrated material with the defibrated material and the binding material and heating, the binding material suitable for the raw material can be selected and used. As a result, the type of binding material can be appropriately set as a condition for manufacturing a sheet in the sheet manufacturing apparatus, and a high quality sheet can be manufactured.

In addition, in the above-described configuration, the control portion may select at least one type of the binding material from the plurality of types of the binding materials based on a type of the raw material defibrated by the defibrating portion and a heating temperature of the heating portion.

According to the configuration, the heating temperature can be set to the appropriate temperature depending on the type of raw material and the binding material, and a high quality sheet can be manufactured.

In addition, in the above-described configuration, the control portion may change a temperature of the heating portion depending on the type of the raw material defibrated by the defibrating portion.

According to the configuration, the heating temperature can be set to the appropriate temperature depending on the type of the raw material, and a high quality sheet can be manufactured.

In addition, in the above-described configuration, the apparatus may further include a plurality of cartridges that contain different types of the binding materials, in which the binding material supply portion may supply the binding material from any one or more of the cartridges under control of the control portion, and the control portion may set one or more of the cartridges to be used among the plurality of cartridges, acquire heating temperature information from the set cartridge, and set a temperature of the heating portion based on the acquired heating temperature information.

According to the configuration, the sheet can be manufactured using the binding material depending on the type of sheet to be manufactured, and the heating temperature suitable for the binding material can be set, so that a high quality sheet can be manufactured.

In addition, in the above-described configuration, the apparatus may further include a reception portion that receives an input related to the type of the raw material, in which the control portion may set the type of the raw material in response to the input received by the reception portion.

According to the configuration, the type of raw material can be set in response to the input, the sheet can be manufactured under the conditions suitable for the set raw material, and a high quality sheet can be manufactured.

In addition, in the above-described configuration, the control portion may change the type of the raw material in response to the input received by the reception portion in a state where the sheet manufacturing apparatus is manufacturing the sheet.

According to the configuration, the type of the raw material can be changed in response to the input in a state where the sheet is manufactured.

In addition, in the above-described configuration, the apparatus may further include a separating portion that separates the raw materials for each type, and a raw material supply portion that supplies the raw materials separated by the separating portion for each type, in which the defibrating portion may defibrate the raw material supplied from the raw material supply portion.

According to the configuration, since the raw materials for each type can be separated and supplied, a sheet under a condition suitable for the raw materials can be manufactured.

In addition, in order to solve the above problems, the present invention is a control method of a sheet manufacturing apparatus, which uses a raw material and heats a material containing fibers to form a sheet, and a heating temperature is set to a temperature depending on a type of the raw material.

According to the present invention, since the heating temperature when manufacturing the sheet is set to the temperature depending on the type of the raw material, the heating temperature can be appropriately set as a condition for manufacturing the sheet in the sheet manufacturing apparatus, and a high quality sheet can be manufactured.

In addition, in order to solve the above problems, in the present invention, a raw material is defibrated, a defibrated material and a binding material are mixed, a mixed mixture is heated by a heating portion to manufacture a sheet, and a heating temperature of the heating portion is set to a temperature depending on a type of the raw material to be defibrated.

According to the present invention, the heating temperature when the raw material is defibrated and the defibrated material and the binding material are mixed and heated is set to a temperature depending on the type of the raw material. As a result, the heating temperature can be appropriately set as a condition for manufacturing a sheet in the sheet manufacturing apparatus, and a high quality sheet can be manufactured.

In addition, in order to solve the above problems, in the present invention, a raw material is defibrated, a defibrated material and a binding material selected from different types of the binding materials are mixed, a mixed mixture is heated by a heating portion to manufacture a sheet, and at least one type of the binding material is selected among a plurality of types of the binding materials depending on a type of the raw material.

According to the present invention, when manufacturing the sheet by defibrating the raw material, mixing the defibrated material with the defibrated material and the binding material and heating, the binding material suitable for the raw material can be selected and used. As a result, the type of binding material can be appropriately set as a condition for manufacturing a sheet in the sheet manufacturing apparatus, and a high quality sheet can be manufactured.

### BRIEF DESCRIPTION OF DRAWINGS

FIG. 1 is a schematic view illustrating a configuration of a sheet manufacturing apparatus according to a first embodiment.

FIG. 2 is a schematic view illustrating a configuration of a supply portion.

FIG. 3 is a schematic view illustrating a configuration of a heating portion at a first position.

FIG. 4 is a schematic view illustrating a configuration of the heating portion at a second position.

FIG. 5 is a schematic view illustrating an example of a displacement mechanism.

FIG. 6 is a schematic view illustrating an example of the displacement mechanism.

FIG. 7 is a schematic view illustrating a configuration of an additive supply portion.

FIG. 8 is a block diagram illustrating a configuration of a control system of the sheet manufacturing apparatus.

FIG. 9 is a block diagram illustrating a functional configuration of a control portion and a storage portion.

FIG. 10 is a table illustrating an example of read data stored in the storage portion.

FIG. 11 is a diagram illustrating an example of a display screen.

FIG. 12 is a flowchart illustrating an operation of the sheet manufacturing apparatus of the first embodiment.

FIG. 13 is a flowchart illustrating an operation of the sheet manufacturing apparatus of the first embodiment.

FIG. 14 is a table illustrating an example of additive setting data stored in the storage portion.

FIG. 15 is a flowchart illustrating an operation of the sheet manufacturing apparatus of the first embodiment.

FIG. 16 is a table illustrating an example of additive setting data stored in the storage portion.

FIG. 17 is a flowchart illustrating an operation of the sheet manufacturing apparatus of the first embodiment.

FIG. 18 is a flowchart illustrating an operation of the sheet manufacturing apparatus of the first embodiment.

FIG. 19 is a flowchart illustrating an operation of the sheet manufacturing apparatus of the first embodiment.

FIG. 20 is a timing chart illustrating an operation example of the sheet manufacturing apparatus of the first embodiment.

FIG. 21 is an explanatory table illustrating an example of an operation state of the sheet manufacturing apparatus.

FIG. 22 is a timing chart illustrating an operation example of a sheet manufacturing apparatus of a second embodiment.

FIG. 23 is a flowchart illustrating an operation of the sheet manufacturing apparatus of the second embodiment.

### DESCRIPTION OF EMBODIMENTS

Hereinafter, favorable embodiments of the present invention will be described in detail with reference to the drawings. The embodiments described below do not limit the contents of the present invention described in the aspects. In addition, not all of the configurations described below are necessarily essential configuration requirements of the present invention.

### First Embodiment

1. Overall Configuration

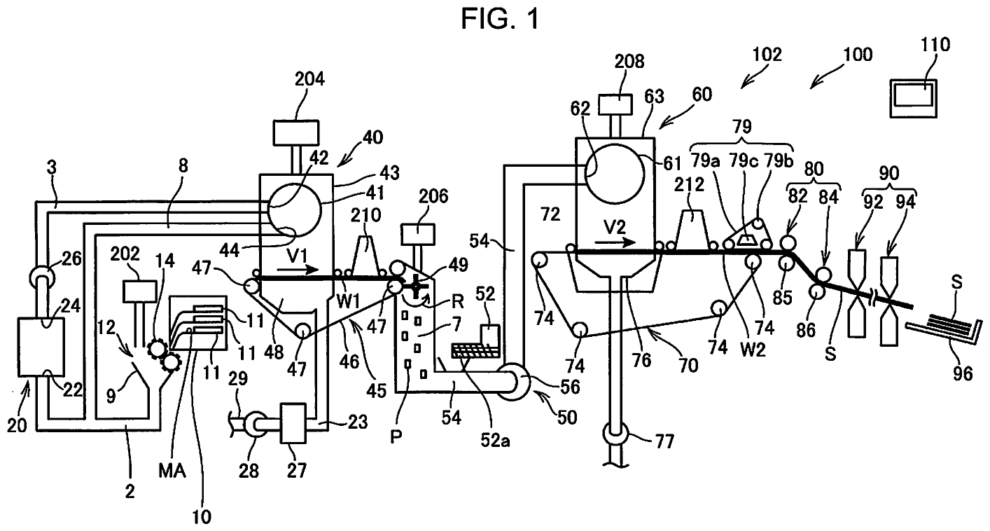

FIG. 1 is a schematic view illustrating a configuration of a sheet manufacturing apparatus 100 according to a first embodiment to which the present invention is applied.

The sheet manufacturing apparatus 100 described in the present embodiment is an apparatus suitable for manufacturing a new sheet by defibrating and fiberizing a raw material MA, which is a used waste sheet such as confidential sheet, in a dry state, pressing, heating, and cutting, for example. By mixing various additives with the fiberized raw material MA, a bonding strength and whiteness of the sheet product may be improved, and functions such as color, smell, and flame retardancy may be added according to the application. In addition, by controlling the density, thickness, and shape of the sheet and molding the sheet, sheets of various thicknesses and sizes can be manufactured according to the application, such as office sheet of standard size such as A4 and A3, business card sheet, and the like.

The sheet manufacturing apparatus 100 is provided with a manufacturing portion 102 and a control device 110. The manufacturing portion 102 manufactures a sheet. The manufacturing portion 102 is provided with a supply portion 10, a coarse crushing portion 12, a defibrating portion 20, a sorting portion 40, a first web forming portion 45, a rotating body 49, a mixing portion 50, an accumulating portion 60, a second web forming portion 70, a transport portion 79, a sheet forming portion 80, and a cutting portion 90.

In the following description, the raw material refers to the raw material MA. In addition, the material of a sheet S is a material obtained by a treatment the raw material MA by each part of the manufacturing portion 102, and refers to a material before forming the sheet S, that is, a material used for manufacturing the sheet S. Specifically, an object processed after being processed by the coarse crushing portion 12, the defibrating portion 20, the sorting portion 40, the first web forming portion 45, the rotating body 49, the mixing portion 50, the accumulating portion 60, and the second web forming portion 70 is referred to as a material. The material includes a coarse crushed material, a defibrated material, a first web W1, a mixture, a second web W2, and the like described later. Those materials that are pressure-heated by the sheet forming portion 80 are referred to as the sheet S.

In addition, the sheet manufacturing apparatus 100 is provided with humidifying portions 202, 204, 206, 208, 210, and 212 that humidify the raw material MA and the material. The humidifying portions 202, 204, 206, 208, 210, and 212 humidify the above-described material and/or a space in which the material moves. A specific configuration of the humidifying portions 202, 204, 206, 208, 210, and 212 is predetermined, and examples thereof include a steam type, a vaporization type, a warm air vaporization type, an ultrasonic type, or the like.

In the present embodiment, the humidifying portions 202, 204, 206, and 208 are configured to include a vaporization type or a warm air vaporization type humidifier. That is, the humidifying portions 202, 204, 206, and 208 have filters (not illustrated) that wet water, and supply humidified air with increased humidity by causing air to pass through the filters. In addition, the humidifying portions 202, 204, 206, and 208 may include heaters (not illustrated) that effectively increase the humidity of the humidified air.

In addition, in the present embodiment, the humidifying portion 210 and the humidifying portion 212 are configured to include ultrasonic humidifiers. That is, the humidifying portions 210 and 212 have vibrating portions (not illustrated) that atomize water, and supply mist generated by the vibrating portions.

The supply portion 10 (raw material supply portion) supplies the raw material MA to the coarse crushing portion 12. The raw material MA from which the sheet manufacturing apparatus 100 manufactures the sheet may be a sheet containing fibers, and examples thereof include a paper, a pulp, a pulp sheet, a cloth containing a nonwoven fabric, or a textile, or the like. In the present embodiment, a configuration in which the sheet manufacturing apparatus 100 uses a waste sheet as the raw material MA is exemplified. The waste sheet is a sheet used at least once for printing or writing, and often has toner and ink attached.

For example, the supply portion 10 is provided with a plurality of stackers 11 (accommodation portions) that accommodate the raw materials MA. In each of the stacker 11, the waste sheets, which are the raw materials MA, are repeatedly accumulated. The supply portion 10 can supply the waste sheet to the coarse crushing portion 12 from any of the plurality of stackers 11.

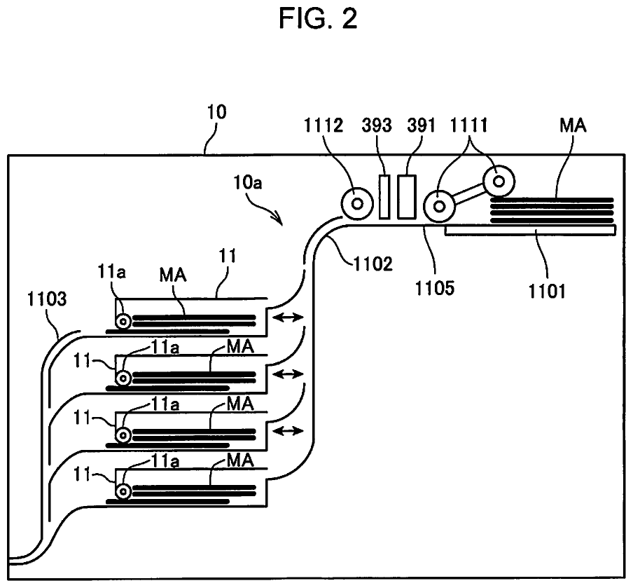

FIG. 2 is a schematic view illustrating a configuration of the supply portion 10.

The supply portion 10 is provided with a placement table 1101 on which the raw material MA is accumulated, and a pair of supply rollers 1111 for feeding the raw material MA placed on the placement table 1101. The supply roller 1111 picks up the raw materials MA one by one and feeds the raw materials MA to a detection transport path 1105. In the detection transport path 1105, a color measurement portion 391 and a scanner 393 are disposed. The color measurement portion 391 is disposed to face the detection transport path 1105, measures the color of a surface of the raw material MA, and outputs a measurement value to the control device 110 (FIG. 1). The scanner 393 is installed, for example, to face the detection transport path 1105, is provided with a light source (not illustrated), and emits light toward the detection transport path 1105. The scanner 393 is provided with a line sensor configured to include a charge coupled device (CCD) sensor, a complementary metal oxide semiconductor (CMOS) sensor, or the like that detects reflected light of the raw material MA. The scanner 393 outputs an image read by the line sensor to the control device 110.

The supply portion 10 is provided with a supply roller 1112 transporting the raw material MA, and the supply roller 1112 supplies the raw material MA from the detection transport path 1105 to a transport path 1102.

The supply portion 10 has a configuration in which the plurality of stackers 11 are disposed in a vertical direction. In the example of FIG. 2, four stackers 11 are disposed slidably in a direction of an arrow, respectively. Each of the stacker 11 is movable from a position separated from the transport path 1102 to a position approaching or abutting on the transport path 1102, and accommodates the raw material MA transported on the transport path 1102 at this position. The movement of the stacker 11 can be controlled by the control device 110. The raw material MA can be accommodated in the stacker 11 by moving any of the stackers 11 on the transport path 1102 side.

The stacker 11 is a box having a space for accumulating the raw material MA inside, and can be, for example, a cassette that can be detached from the supply portion 10. Each of the stacker 11 is provided with a feed roller 11a for feeding the raw material MA accommodated therein. The feed roller 11a feeds the raw materials MA in the stacker 11 one by one to a supply path 1103.

The supply path 1103 is a transport path through which the raw material MA is fed from each of the plurality of stackers 11 of the supply portion 10 and the raw material MA is transported to the coarse crushing portion 12 (FIG. 1).

In the supply portion 10, the raw material MA such as the waste sheet is placed on the placement table 1101 by the user, and when an operation of the sheet manufacturing apparatus 100 starts, the supply roller 1111 feeds the raw material MA one by one. The raw material MA is transported on the detection transport path 1105, and during this transport, the color measurement portion 391 measures the color on the raw material MA, and the scanner 393 reads the raw material MA.

Here, the control device 110 acquires an output value indicating the result of the color measurement performed by the color measurement portion 391 and an image read by the scanner 393. The control device 110 determines the color of the surface of the raw material MA based on the output value of the color measurement portion 391, and specifies a type of the raw material MA. The type of the raw material MA is, for example, a plain sheet copy (PPC) sheet, a Kraft sheet, a recycled sheet, or the like. For example, the control device 110 can obtain the whiteness of non-printed portion without toner, ink and the like from the output value of the color measurement portion 391, estimate the presence or absence of exposure, and determine whether or not the non-printed portion is a Kraft sheet. Here, the control device 110 may determine the type of the raw material MA based on both the output value of the color measurement portion 391 and the image read by the scanner 393. The control device 110 detects the amount, type (ink, toner, resin toner, and the like) of the coloring material adhering to the raw material MA, the area of the coloring material occupied in the surface area of the raw material MA, and the like, from the output value of the color measurement portion 391 and the image read by the scanner 393.

The control device 110 drives the supply roller 1112 to feed the raw material MA to the transport path 1102, and further moves the stacker 11 corresponding to the determined type of the raw material MA on the transport path 1102 side. As a result, the raw material MA is accommodated in the different stackers 11 for each type. That is, in each of the stacker 11, one type of raw material MA is collectively accommodated. Therefore, a specific type of raw material MA can be selected by selecting the stacker 11. In the stacker 11, the feed roller 11a is driven by the control of the control device 110, the raw material MA is fed to the supply path 1103, and is supplied to the coarse crushing portion 12.

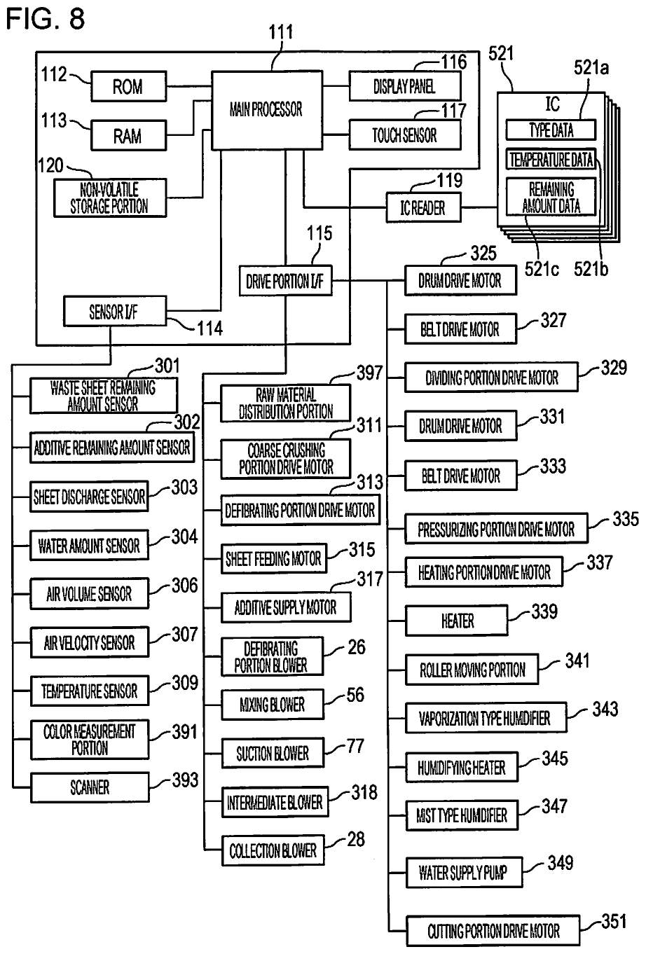

In the configuration of the supply portion 10, the color measurement portion 391, the scanner 393, the supply roller 1111, and the transport path 1102 constitutes separating portion 10a separating the raw material MA for each type and a raw material distribution portion 397 (FIG. 8) described later.

Returning to FIG. 1, the coarse crushing portion 12 cuts (crushes) the raw material MA supplied from the supply portion 10 with a coarse crushing blade 14 to form a coarse crushed piece. The coarse crushing blade 14 cuts the raw material MA in air such as in the atmosphere (in air). For example, the coarse crushing portion 12 is provided with a pair of coarse crushing blades 14 cutting with the raw material MA interposed, and a drive portion rotating the coarse crushing blades 14, and can be configured similar to a so-called shredder. The shape and size of the coarse crushed piece are predetermined, and may be suitable for a defibrating treatment in the defibrating portion 20. For example, the coarse crushing portion 12 cuts the raw material MA into pieces of sheet having a size of 1 to several cm square or less.

The coarse crushing portion 12 has a chute (hopper) 9 receiving the coarse crushed piece cut and dropped by the coarse crushing blade 14. For example, the chute 9 has a tapered shape in which the width gradually narrows in the direction where the coarse crushed pieces flow (travelling direction). Therefore, the chute 9 can receive many coarse crushed pieces. A tube 2 communicating with the defibrating portion 20 is coupled to the chute 9, and the tube 2 forms a transport path for transporting the coarse crushed piece cut by the coarse crushing blade 14 to the defibrating portion 20. The coarse crushed piece is collected by the chute 9 and transferred (transported) to the defibrating portion 20 through the tube 2.

Humidified air is supplied from the humidifying portion 202 to the chute 9 included in the coarse crushing portion 12 or in the vicinity of the chute 9. As a result, it is possible to suppress the phenomenon that the coarse crushed material cut by the coarse crushing blade 14 is adsorbed to the inner surface of the chute 9 or the tube 2 by static electricity. In addition, since the coarse crushed material cut by the coarse crushing blade 14 and the humidified (high humidity) air are transferred to the defibrating portion 20, the effect of suppressing adhesion of a defibrated material inside the defibrating portion 20 can also be expected. In addition, the humidifying portion 202 may supply the humidified air to the coarse crushing blade 14 to discharge the raw material MA supplied by the supply portion 10. In addition, the charge removal may be performed using an ionizer and the humidifying portion 202.

The defibrating portion 20 defibrates the coarse crushed material cut by the coarse crushing portion 12. More specifically, the defibrating portion 20 defibrates the coarse crushed piece cut by the coarse crushing portion 12 to generate a defibrated material. Here, “to defibrate” refers to unravel a material to be defibrated in which a plurality of fibers are bound into a fiber one by one. The defibrating portion 20 also has a function of separating substances such as resin particles, ink, toner, anti-smearing agent, and the like attached to the material to be defibrated from fibers.

The material passed through the defibrating portion 20 is referred to as “defibrated material”. The “defibrated material” may contain resin (resin for bonding a plurality of fibers) particles separated from fibers when unraveling fibers, coloring agents such as ink and toner, or additives such as bleed inhibitor and paper strength enhancer in addition to unraveled defibrated fibers. The shape of unraveled defibrated material is a string or ribbon shape. The unraveled defibrated material may exist in a state not intertwined with other unraveled fiber (independent state), or may exist in a state of being intertwined with other unraveled defibrated material to form a lump (state of forming so-called “lump”).

The defibrating portion 20 defibrates in a dry method. Here, performing a treatment such as defibration in the air such as atmosphere (in air) rather than in liquid is referred to as the dry method. In the present embodiment, the defibrating portion 20 is configured to use an impeller mill. Specifically, the defibrating portion 20 is provided with a rotor (not illustrated) rotating at high speed, and a liner (not illustrated) located on an outer periphery of the rotor. The coarse crushed pieces cut by the coarse crushing portion 12 are defibrated by being interposed between the rotor of the defibrating portion 20 and the liner. The defibrating portion 20 generates an air flow by the rotation of the rotor. By the air flow, the defibrating portion 20 can suck the coarse crushed piece from the tube 2 and can transport the defibrated material to a discharge port 24. The defibrated material is fed from the discharge port 24 to a tube 3 and transferred to the sorting portion 40 via the tube 3.

As described above, the defibrated material generated by the defibrating portion 20 is transported from the defibrating portion 20 to the sorting portion 40 by the air flow generated by the defibrating portion 20. Furthermore, in the present embodiment, the sheet manufacturing apparatus 100 is provided with a defibrating portion blower 26 which is an air flow generating device, and the defibrated material is transported to the sorting portion 40 by the air flow generated by the defibrating portion blower 26. The defibrating portion blower 26 is attached to the tube 3, sucks air and the defibrated material from the defibrating portion 20, and blows air to the sorting portion 40.

The sorting portion 40 includes an introduction port 42 through which the defibrated material defibrated by the defibrating portion 20 and the air flow from the tube 3. The sorting portion 40 sorts the defibrated material to be introduced into the introduction port 42 according to the length of the fiber. Specifically, the sorting portion 40 sorts a defibrated material having a size of a predetermined size or less as a first sorted material, and a defibrated material larger than the first sorted material as a second sorted material among the defibrated materials defibrated by the defibrating portion 20. The first sorted material includes fibers or particles, and the second sorted material includes, for example, a large fiber, an undefibrated piece (coarse crushed piece not sufficiently defibrated), a lump in which defibrated fibers are aggregated or interwined, and the like.

In the present embodiment, the sorting portion 40 includes a drum portion 41 (sieve portion) and a housing portion (cover portion) 43 accommodating the drum portion 41.

The drum portion 41 is a sieve of a cylinder rotationally driven by a motor. The drum portion 41 includes a mesh (filter, screen) and functions as a sieve. By this mesh, the drum portion 41 sorts the first sorted material smaller than the size of a mesh sieve (opening) and the second sorted material larger than the mesh sieve. As the mesh of the drum portion 41, for example, a wire mesh, an expanded metal obtained by stretching a metal plate with a notch, and a punching metal having a hole formed in a metal plate by a pressing machine or the like can be used.

The defibrated material introduced into the introduction port 42 and the air flow are fed into the inside of the drum portion 41, and the first sorted material drops downward from the mesh of the drum portion 41 by the rotation of the drum portion 41. The second sorted material which cannot pass through the mesh of the drum portion 41 is flowed by the air flow flowing into the drum portion 41 from the introduction port 42, is led to the discharge port 44, and is fed to a tube 8.

The tube 8 couples the inside of the drum portion 41 and the tube 2. The second sorted material flowing through the tube 8 and the coarse crushed piece cut by the coarse crushing portion 12 flow through the tube 2 and are led to the introduction port 22 of the defibrating portion 20. As a result, the second sorted material is returned to the defibrating portion 20, and is defibrated.

In addition, the first sorted material sorted by the drum portion 41 is dispersed in the air through the mesh of the drum portion 41 and is descended toward a mesh belt 46 of the first web forming portion 45 located below the drum portion 41.

The first web forming portion 45 (separation portion) includes the mesh belt 46 (separation belt), a roller 47, and a suction portion (suction mechanism) 48. The mesh belt 46 is an endless belt and is suspended by three rollers 47 and is transported in a direction indicated by the arrow in the drawing by the movement of the rollers 47. The surface of the mesh belt 46 is configured to include a mesh in which openings of a predetermined size are arranged. Among the first sorted material descending from the sorting portion 40, fine particles of a size that passes through the mesh fall downwards the mesh belt 46, and fibers of a size that cannot pass through the mesh are accumulated on the mesh belt 46, and are transported in the direction of the arrow V1 with the mesh belt 46. The fine particles falling from the mesh belt 46 include relatively small particles and low density particles (resin particles, coloring agents, additives, and the like), and are removed materials that the sheet manufacturing apparatus 100 does not use for manufacturing the sheet S.

The mesh belt 46 moves at a speed V1 during the operation of manufacturing the sheet S. The transport speed V1 of the mesh belt 46 and the start and stop of transport by the mesh belt 46 are controlled by the control device 110.

Here, “during operation” means while the sheet manufacturing apparatus 100 is manufacturing the sheet S. For example, “during operation” means an activation sequence performed when the sheet manufacturing apparatus 100 activates, a stop sequence performed when the sheet manufacturing apparatus 100 stops, and an operation excluding a second state (standby state) described later.

Therefore, the defibrated material subjected to the defibrating treatment in the defibrating portion 20 is sorted into the first sorted material and the second sorted material by the sorting portion 40, and the second sorted material is returned to the defibrating portion 20. In addition, the first web forming portion 45 removes the removed material from the first sorted material. The remainder of the first sorted material excluding the removed material is a material suitable for manufacturing the sheet S. This material is accumulated on the mesh belt 46 to form the first web W1.

The suction portion 48 sucks air from below the mesh belt 46. The suction portion 48 is coupled to a dust collection portion 27 (dust collection device) via a tube 23. The dust collection portion 27 separates the particulates from the air flow. A collection blower 28 is installed downstream of the dust collection portion 27, and the collection blower 28 functions as a dust collection suction portion that sucks air from the dust collection portion 27. In addition, the air discharged by the collection blower 28 is discharged out of the sheet manufacturing apparatus 100 through a tube 29.

In this configuration, air is sucked from the suction portion 48 through the dust collection portion 27 by the collection blower 28. In the suction portion 48, the fine particles passing through the mesh of the mesh belt 46 are sucked with the air, and are sent to the dust collection portion 27 through the tube 23. The dust collection portion 27 separates and accumulates the fine particles passed through the mesh belt 46 from the air flow.

Therefore, the fibers from which the removed materials are removed from the first sorted material are accumulated on the mesh belt 46 to form the first web W1. The suction by the collection blower 28 promotes the formation of the first web W1 on the mesh belt 46, and the removed material is rapidly removed.

Humidified air is supplied by the humidifying portion 204 to the space including the drum portion 41. The humidified air humidifies the first sorted material inside the sorting portion 40. As a result, the adhesion of the first sorted material to the mesh belt 46 by electrostatic force can be weakened, and the first sorted material can be easily separated from the mesh belt 46. Furthermore, it is possible to suppress that the first sorted material adheres to the rotating body 49 and the inner wall of the housing portion 43 by electrostatic force. In addition, the removed material can be efficiently sucked by the suction portion 48.

In the sheet manufacturing apparatus 100, the configuration for sorting and separating the first defibrated material and the second defibrated material is not limited to the sorting portion 40 provided with the drum portion 41. For example, a configuration may be adopted in which the defibrated material subjected to the defibrating treatment by the defibrating portion 20 is classified by a classifier. For example, as the classifier, a cyclone classifier, an elbow jet classifier, or an Eddie classifier can be used. Using these classifiers, it is possible to sort and separate the first sorted material and the second sorted material. Furthermore, the above classifier can realize a configuration for separating and removing the removed material including relatively small materials of defibrated materials and low density materials (resin particles, coloring agents, additives, and the like). For example, the fine particles contained in the first sorted material may be removed from the first sorted material by the classifier. In this case, for example, the second sorted material may be returned to the defibrating portion 20, the removed material may be collected by the dust collection portion 27, and the first sorted material removing the removed material may be sent to a tube 54.

On the downstream of the sorting portion 40 in the transport path of the mesh belt 46, air containing mist is supplied by the humidifying portion 210. Mist, which is fine particles of water generated by the humidifying portion 210, descends toward the first web W1 to supply moisture to the first web W1. As a result, the amount of water contained in the first web W1 is adjusted, and adsorption of fibers to the mesh belt 46 due to static electricity can be suppressed.

The sheet manufacturing apparatus 100 is provided with the rotating body 49 that divides the first web W1 accumulated on the mesh belt 46. The first web W1 is separated from the mesh belt 46 at a position where the mesh belt 46 is folded back by the roller 47 and is divided by the rotating body 49.

The first web W1 is a soft material in which the fibers are accumulated to form a web, and the rotating body 49 loosens the fibers of the first web W1 and processes the resin in a state easy to mix in the mixing portion 50.

Although the configuration of the rotating body 49 is predetermined, the configuration can have a rotating blade shape having a plate-shaped blade and rotates in the present embodiment. The rotating body 49 is disposed at a position where the first web W1 separated from the mesh belt 46 and the blade are in contact with each other. By rotation of the rotating body 49 (for example, rotation in the direction indicated by the arrow R in the drawing), the blade collides with the first web W1 which is separated and transported from the mesh belt 46 and is divided to generate a subdivided body P.

The rotating body 49 is preferably installed at a position where the blades of the rotating body 49 do not collide with the mesh belt 46. For example, the distance between a tip end of the blade of the rotating body 49 and the mesh belt 46 can be 0.05 mm or more and 0.5 mm or less. In this case, the rotating body 49 can efficiently divide the first web W1 without damaging the mesh belt 46.

The subdivided body P divided by the rotating body 49 descend inside a tube 7 and are transferred (transported) to the mixing portion 50 by the air flow flowing inside the tube 7.

In addition, humidified air is supplied to the space including the rotating body 49 by the humidifying portion 206. As a result, it is possible to suppress the phenomenon in which the fibers are adsorbed to the inside of the tube 7 and the blades of the rotating body 49 by static electricity. In addition, since the air with high humidity is supplied to the mixing portion 50 through the tube 7, the influence of static electricity can be suppressed in the mixing portion 50.

The mixing portion 50 is provided with an additive supply portion 52 supplying an additive containing a resin, the tube 54 communicating with the tube 7 and through which an air flow containing the subdivided body P flows, and a mixing blower 56. The subdivided body P is fibers from which the removed material is removed from the first sorted material passed through the sorting portion 40 as described above. The mixing portion 50 mixes the additive containing the resin with the fiber forming the subdivided body P. For example, the additive acts as a binding material to bind the fibers.

In the mixing portion 50, an air flow is generated by the mixing blower 56, and is transported in the tube 54 while mixing the subdivided body P and the additive. In addition, the subdivided body P is loosened in the process of flowing inside the tube 7 and the tube 54, and is finer and fibrous.

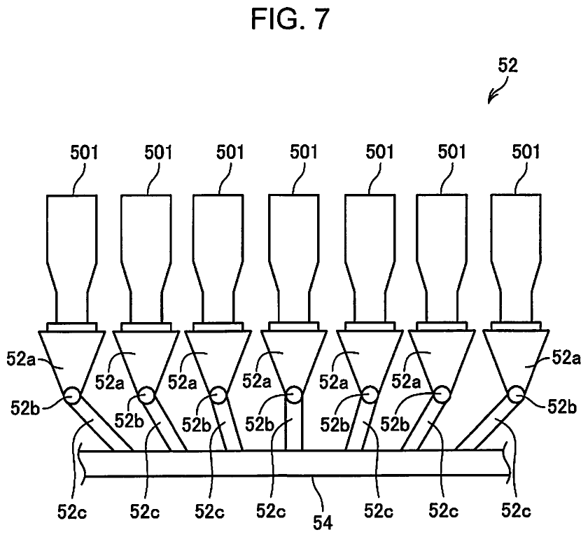

An additive cartridge 501 (cartridge) accumulating the additive is detachably attached to the additive supply portion 52, as illustrated in FIG. 7. The additive supply portion 52 supplies the additive in the additive cartridge 501 to the tube 54. The configuration may be such that the additive cartridge 501 attached to the additive supply portion 52 is replenished with the additive. The configuration of the additive supply portion 52 will be described later with reference to FIG. 7.

The additive contained in the additive cartridge 501 and supplied by the additive supply portion 52 includes a resin for binding a plurality of fibers. The resin contained in the additive is a thermoplastic resin or a thermosetting resin, and examples thereof include AS resin, ABS resin, polypropylene, polyethylene, polyvinyl chloride, polystyrene, acrylic resin, polyester resin, polyethylene terephthalate, polyphenylene ether, polybutylene terephthalate, nylon, polyamide, polycarbonate, polyacetal, polyphenylene sulfide, polyether ether ketone, and the like. These resins may be used alone or as a mixture as appropriate. That is, the additive may contain a single substance, may be a mixture, or may contain a plurality of types of the particles, each consisting of a single or a plurality of substances. In addition, the additive may be in a fibrous form or powder form.

The resin contained in the additive is melted by heating to bind a plurality of fibers. Therefore, in a state where the resin is mixed with the fibers, the fibers are not bonded to each other in the state where the resin is not heated to the melting temperature.

In addition, the additive supplied by the additive supply portion 52 may contain a coloring agent for coloring the fibers, an aggregation inhibitor for suppressing aggregation of the fibers or aggregation of the resins, and a flame retardant for causing fibers less flammable, in addition to the resin binding the fibers, depending on the type of the sheet to be manufactured. In addition, the additive not containing the coloring agent may be colorless, may be light enough to be considered colorless, or may be white.

Due to the air flow generated by the mixing blower 56, the subdivided body P descending in the tube 7 and the additive supplied by the additive supply portion 52 are sucked inside the tube 54 and pass through inside the mixing blower 56. By the action of the air flow generated by the mixing blower 56 and/or the action of the rotating portion of the mixing blower 56 such as the blades, the fibers forming the subdivided body P and the additives are mixed, and this mixture (mixture of the first sorted material and the additive) is transferred to the accumulating portion 60 through the tube 54.

The mechanism mixing the first sorted material and the additive is not particularly limited, and may be a mechanism in which stirring is performed by a blade rotating at a high speed, may be a mechanism using the rotation of the container such as a V-type mixer, or these mechanisms may be installed before or after the mixing blower 56.

The accumulating portion 60 accumulates the defibrated material defibrated by the defibrating portion 20. More specifically, the accumulating portion 60 introduces the mixture passed through the mixing portion 50 from the introduction port 62, loosens the intertwined defibrated material (fibers), and causes the mixture to descend in the air while dispersing. Furthermore, when the resin of the additive supplied from the additive supply portion 52 is fibrous, the accumulating portion 60 loosens the intertwined resin. As a result, the accumulating portion 60 can accumulate the mixture uniformly on the second web forming portion 70.

The accumulating portion 60 includes a drum portion 61 and a housing portion (cover portion) 63 accommodating the drum portion 61. The drum portion 61 is a sieve of a cylinder rotationally driven by a motor. The drum portion 61 includes a mesh (filter, screen) and functions as a sieve. By this mesh, the drum portion 61 causes fibers and particles smaller than the mesh sieve (opening) to pass through and drop from the drum portion 61. For example, a configuration of the drum portion 61 is the same as a configuration of the drum portion 41.

In addition, the “sieve” of the drum portion 61 may not have a function which sorts a specific target object. That is, the “sieve” used as the drum portion 61 means a portion provided with the mesh, and the drum portion 61 may descend all of the mixture introduced to the drum portion 61.

The second web forming portion 70 is disposed below the drum portion 61. The second web forming portion 70 accumulates passing materials passed through the accumulating portion 60 to form a second web W2. For example, the second web forming portion 70 includes a mesh belt 72, the roller 74, and a suction mechanism 76. The accumulating portion 60 and the second web forming portion 70 correspond to a web forming portion. In addition, the drum portion 61 corresponds to a sieve portion, and the second web forming portion 70 (in particular, mesh belt 72) corresponds to an accumulating portion.

The mesh belt 72 is an endless belt and is suspended by a plurality of rollers 74, and is transported in the direction indicated by the arrow V2 in the drawing by the movement of the rollers 74. For example, the mesh belt 72 is made of metal, resin, cloth, non-woven fabric, or the like. The surface of the mesh belt 72 is configured to include a mesh in which openings of a predetermined size are arranged. Among the fibers and particles descending from the drum portion 61, fine particles of a size passing through the mesh fall below the mesh belt 72, fibers of a size which cannot pass through the mesh are accumulated on the mesh belt 72, and transported in the direction of the arrow with the mesh belt 72. The mesh belt 72 moves at a constant speed V2 during the operation of manufacturing the sheet S. The operation is as described above.

A moving speed V2 of the mesh belt 72 can be regarded as the speed at which the second web W2 is transported, and the speed V2 can be referred to as a transport speed of the second web W2 at the mesh belt 72.

The mesh of the mesh belt 72 is fine and can be sized so as not to pass most of the fibers and particles descending from the drum portion 61.

The suction mechanism 76 is provided below the mesh belt 72 (side opposite to accumulating portion 60). The suction mechanism 76 is provided with a suction blower 77, and can generate an air flow (air flow from the accumulating portion 60 toward the mesh belt 72) directed downward to the suction mechanism 76 by the suction force of the suction blower 77.

The suction mechanism 76 sucks the mixture dispersed in the air by the accumulating portion 60 onto the mesh belt 72. As a result, the formation of the second web W2 on the mesh belt 72 can be promoted, and the discharge speed from the accumulating portion 60 can be increased. Furthermore, the suction mechanism 76 can form a downflow in a dropping path of the mixture, and can prevent intertwined of defibrated substances and additives during dropping.

The suction blower 77 (accumulation suction portion) may discharge the air sucked from the suction mechanism 76 to the outside of the sheet manufacturing apparatus 100 through a collection filter (not illustrated).

Alternatively, the air sucked by the suction blower 77 may be sent to the dust collection portion 27, and the removal material contained in the air sucked by the suction mechanism 76 may be collected.

Humidified air is supplied from the humidifying portion 208 to a space including the drum portion 61. By the humidified air, the inside of the accumulating portion 60 can be humidified, the adhesion of fibers and particles to the housing portion 63 by electrostatic force can be suppressed, the fibers and particles can be rapidly descended to the mesh belt 72, and the second web W2 having a preferable shape can be formed.

As described above, by passing through the accumulating portion 60 and the second web forming portion 70 (web forming step), the second web W2 in a soft and bloated state is formed with a large amount of air. The second web W2 accumulated on the mesh belt 72 is transported to the sheet forming portion 80.

In the transport path of the mesh belt 72, air containing mist is supplied to the downstream of the accumulating portion 60 by the humidifying portion 212. As a result, the mist which the humidifying portion 212 generates is supplied to the second web W2, and the moisture content which the second web W2 contains is adjusted. As a result, adsorption of fibers to the mesh belt 72 due to static electricity can be suppressed.

The sheet manufacturing apparatus 100 is provided with the transport portion 79 transporting the second web W2 on the mesh belt 72 to the sheet forming portion 80. For example, the transport portion 79 includes a mesh belt 79a, a roller 79b, and a suction mechanism 79c.

The suction mechanism 79c is provided with an intermediate blower 318 (FIG. 8) and generates an upward air flow on the mesh belt 79a by the suction force of the intermediate blower 318. The air flow sucks the second web W2, and the second web W2 is separated from the mesh belt 72 and adsorbed to the mesh belt 79a. The mesh belt 79a is moved by the rotation of the roller 79b and transports the second web W2 to the sheet forming portion 80.

As described above, the transport portion 79 separates the second web W2 formed on the mesh belt 72 from the mesh belt 72 and transports the second web W2.

The sheet forming portion 80 forms the sheet S from the accumulated material accumulated in the accumulating portion 60. More specifically, the sheet forming portion 80 presses and heats the second web W2 (accumulated material) accumulated on the mesh belt 72 and transported by the transport portion 79 to form the sheet S. In the sheet forming portion 80, a plurality of fibers in the mixture are bound to each other via the additive (resin) by applying heat to the fibers of the defibrated material contained in the second web W2 and the additive. The sheet forming portion 80 corresponds to a sheet forming portion and a maximum load transport portion.

The sheet forming portion 80 is provided with a pressurizing portion 82 pressing the second web W2, and a heating portion 84 heating the second web W2 pressed by the pressurizing portion 82.

The pressurizing portion 82 includes a pair of calender rollers 85 (pressure rollers), and interposes and presses the second web W2 with a predetermined nip pressure. The second web W2 is reduced in thickness by being pressurized, and the density of the second web W2 is increased. One of the pair of calender rollers 85 is a drive roller driven by a pressurizing portion drive motor 335 (FIG. 8), and the other is a driven roller. The calender roller 85 is rotated by the drive force of the pressurizing portion drive motor 335, and transports the second web W2 having a high density by the pressure toward the heating portion 84.

The heating portion 84 can be configured using, for example, a heating roller (heater roller), a heat press molding machine, a hot plate, a hot air blower, an infrared heater, and a flash heater. In the present embodiment, the heating portion 84 is provided with a pair of heating rollers 86. The heating roller 86 is heated to a preset temperature by a heater provided internally or externally. One of the pair of heating rollers 86 is a driving roller driven by a heating portion drive motor 337 (FIG. 8), and the other is a driven roller. The heating roller 86 interposes the sheet S pressed by the calender roller 85 and applies heat to form the sheet S. The heating roller 86 is rotated by the drive force of the heating portion drive motor 337 and transports the sheet S toward the cutting portion 90.

The number of calender rollers 85 provided in the pressurizing portion 82 and the number of heating rollers 86 provided in the heating portion 84 are not particularly limited.

In addition, in a step of manufacturing the sheet S by the sheet manufacturing apparatus 100, the boundary between the second web W2 and the sheet S is predetermined. In the present embodiment, in the sheet forming portion 80 that processes the second web W2 to form the sheet S, the second web W2 is pressed by the pressurizing portion 82, and the second web pressed by the pressurizing portion 82 is further heated by the heating portion 84 and referred to as a sheet S. That is, a sheet in which fibers are bound by an additive is referred to as a sheet S. The sheet S is transported to the cutting portion 90.

The cutting portion 90 cuts the sheet S formed by the sheet forming portion 80. In the present embodiment, the cutting portion 90 includes a first cutting portion 92 cutting the sheet S in a direction intersecting the transport direction of the sheet S (F in the drawing), and a second cutting portion 94 cutting the sheet S in a direction parallel to the transport direction F. The second cutting portion 94 cuts, for example, the sheet S passed through the first cutting portion 92.

As described above, a single-cut sheet S of a predetermined size is formed. The cut single-cut sheet S is discharged to a discharge portion 96. The discharge portion 96 is provided with a tray or stacker on which the sheet S having a predetermined size is placed.

In the above configuration, the humidifying portions 202, 204, 206, and 208 may be configured to include a single vaporization type humidifier. In this case, the humidified air generated by one humidifier may be branched and supplied to the coarse crushing portion 12, the housing portion 43, the tube 7, and the housing portion 63. This configuration can be easily realized by branching and installing a duct (not illustrated) for supplying the humidified air. In addition, as a matter of course, the humidifying portions 202, 204, 206, and 208 can be configured to include two or three vaporization type humidifiers.

In addition, in the above configuration, the humidifying portions 210 and 212 may be configured to include one ultrasonic type humidifier, or may be configured to include two ultrasonic type humidifiers. For example, air containing mist generated by one humidifier can be branched and supplied to the humidifying portion 210 and the humidifying portion 212.

In addition, the blowers provided in the above-described sheet manufacturing apparatus 100 are not limited to the defibrating portion blower 26, the collection blower 28, the mixing blower 56, the suction blower 77, and the intermediate blower 318. For example, as a matter of course, a fan can be provided in the duct for assisting each blower described above.

In addition, in the above configuration, although the coarse crushing portion 12 first crushes the raw material MA and manufactures the sheet S from the crushed coarse crushed piece, for example, the sheet S can be manufactured using fibers as a raw material. For example, a configuration may be such that the fibers equivalent to the defibrated material subjected to the defibrating treatment by the defibrating portion 20 can be input to the drum portion 41 as a raw material. In addition, a configuration may be such that the fiber equivalent to the first sorted material separated from the defibrated material can be input to the tube 54 as a raw material. In this case, the sheet S can be manufactured by supplying the sheet manufacturing apparatus 100 with fibers obtained by processing waste sheet, pulp, and the like.

2. Configuration of Heating Portion

The sheet manufacturing apparatus 100 heats and presses the second web W2 (accumulated material formed by the accumulating portion 60) in the above-described sheet forming portion 80 (heating portion 84) to form the sheet S. In the example of FIG. 1, the heating portion 84 is simplified and illustrated as a pair of heating rollers 86. Hereinafter, the heating portion 84 of the sheet manufacturing apparatus 100 of the present embodiment will be described in detail.

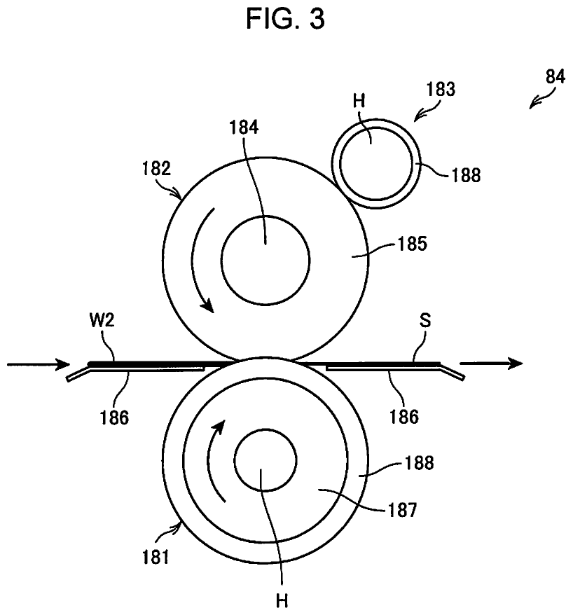

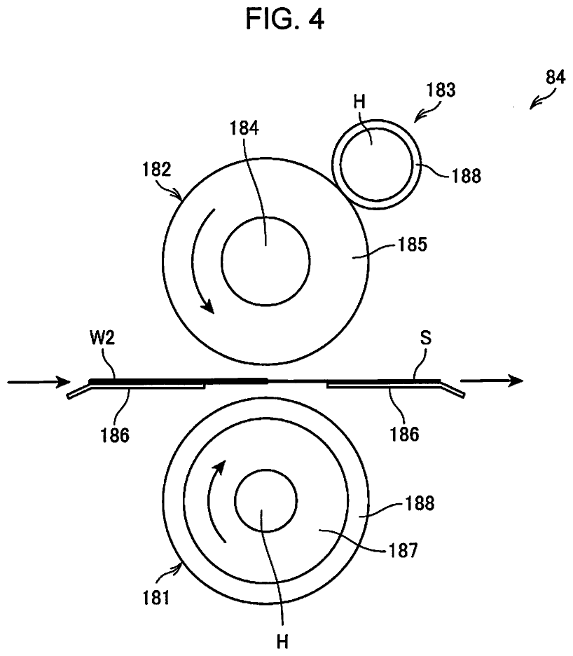

FIGS. 3 and 4 are views schematically illustrating an example of the heating portion 84 of the present embodiment. The heating portion 84 includes a rotatable first rotating body 181, a rotatable second rotating body 182, and a heating body 183. Each of the first rotating body 181 and the second rotating body 182 has a roller shape having an outer peripheral surface that moves with rotation, and the second web W2 is held between the first rotating body 181 and the second rotating body 182 and heated and pressurized to form the sheet S. In addition, the heating body 183 is disposed so as to heat the outer peripheral surface of the second rotating body 182. Each of the first rotating body 181 and the heating body 183 is a heating roller having a heat source H (for example, halogen heater) inside. Instead of heating the second rotating body 182 by the heating body 183, the second rotating body 182 may be heated by a non-contact heater (for example, infrared heater or carbon heater). Each heat source H of the heating portion 84 generates heat under the control of the control device 110 to heat the first rotating body 181 and the second rotating body 182. In addition, the heating portion 84 includes a temperature sensor 309 (FIG. 8) that detects the temperature of the first rotating body 181 and the second rotating body 182 (for example, temperature of the outer peripheral surface). The control device 110 can acquire the detection value of the temperature sensor 309.

The second rotating body 182 is configured to include a core metal 184 at the center of rotation and a soft body 185 disposed so as to surround the periphery thereof. The core metal 184 is made of metal such as aluminum, iron, stainless steel and the like, and the soft body 185 is made of rubber such as silicone rubber and urethane rubber. In addition, the first rotating body 181 and the heating body 183 are each formed of a hollow metal core metal 187, and a fluorine-coated release layer 188 is provided on the surface thereof.

The heating portion 84 of the present embodiment is configured to be displaceable between the first position for the first rotating body 181 and the second rotating body 182 to hold the web W and heat and press the web W (refer to FIG. 3), and the second position where the first rotating body 181 and the second rotating body 182 are separated from each other (refer to FIG. 4). The first position can be referred to as a nip position where the first rotating body 181 and the second rotating body 182 can interpose the second web W2. On the other hand, the second position can be referred to as a position where the first rotating body 181 and the second rotating body 182 are separated from each other and the nip is released.

The sheet manufacturing apparatus 100 of the present embodiment is provided with a displacement mechanism for displacing the position of the heating portion 84. The displacement mechanism may displace either one of the first rotating body 181 and the second rotating body 182, or may displace both the first rotating body 181 and the second rotating body 182. As illustrated in FIGS. 3 and 4, by providing a supporting portion 186 (guide) supporting the second web W2 in the vicinity of the first rotating body 181 and the second rotating body 182, the first rotating body 181 and the second rotating body 182 may not be in contact with the second web W2 at the second position. The supporting portion 186 is provided at each of a position on the upstream of the transport direction and a position on the downstream of the transport direction of the second web W2 with respect to the interposing portion (nip portion) of the first rotating body 181 and the second rotating body 182.

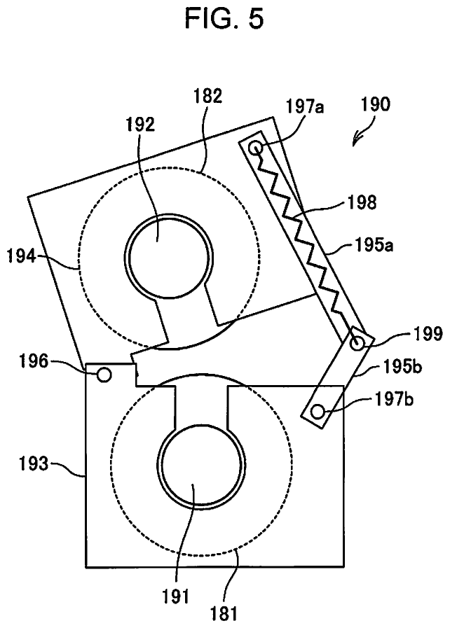

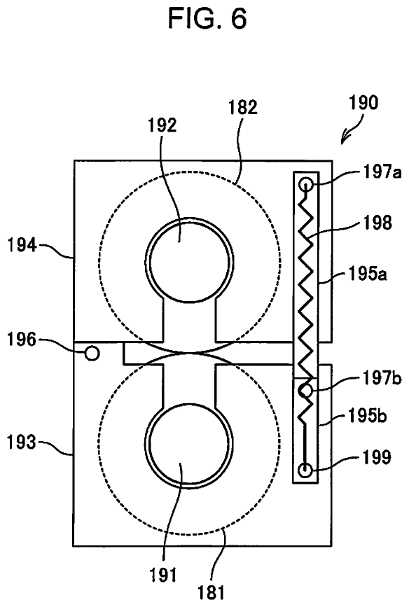

FIGS. 5 and 6 are views schematically illustrating an example of a displacement mechanism of the present embodiment.

A displacement mechanism 190 includes a first bearing portion 193 for rotatably supporting a rotating shaft 191 of the first rotating body 181, a second bearing portion 194 for rotatably supporting a rotating shaft 192 of the second rotating body 182, a first rod 195a, and a second rod 195b. The first bearing portion 193 and the second bearing portion 194 are rotatably (relatively movable) coupled to each other around a rotation shaft 196. One end side of the first rod 195a is provided on the second bearing portion 194 so as to be rotatable around a rotation shaft 197a, and one end side of the second rod 195b is provided on the first bearing portion 193 so as to be rotatable around a rotation shaft 197b. A biasing member 198 (spring) is provided on the first rod 195a. One end of the biasing member 198 is coupled to the rotation shaft 197a, and the other end of the biasing member 198 is coupled to the other end 199 of the second rod 195b. The displacement mechanism 190 has a drive portion that rotationally drives the second rod 195b around the rotation shaft 197b.

FIG. 5 illustrates a state where the heating portion 84 is in the second position, and FIG. 6 illustrates a state where the heating portion 84 is in the first position. When the second rod 195b is rotated clockwise in the state illustrated in FIG. 5 (second position), the first rotating body 181 and the second rotating body 182 are displaced to the first position where the first rotating body 181 and the second rotating body 182 are in contact with each other, as illustrated in FIG. 6. At this time, the first bearing portion 193 (first rotating body 181) is biased toward the second bearing portion 194 (second rotating body 182) by the biasing member 198, and the second bearing portion 194 is biased toward the first bearing portion 193. In the first position, the first rotating body 181 and the second rotating body 182 may not be in contact with each other as long as the first rotating body 181 and the second rotating body 182 can interpose, heat, and press the second web W2.

In addition, when the second rod 195b is rotated counterclockwise in the state illustrated in FIG. 6 (first position), the first rotating body 181 and the second rotating body 182 are displaced to a second position where the first rotating body 181 and the second rotating body 182 are separated from each other.

The displacement mechanism 190 illustrated in FIGS. 5 and 6 is driven by a roller moving portion 341 (FIG. 8) provided in the sheet manufacturing apparatus 100, and is displaceable to the first position of FIG. 5 and the second position of FIG. 6. For example, the roller moving portion 341 is configured to include a motor, an actuator, or the like, operates according to the control of the control device 110, and functions as the above-described drive portion. That is, in the present embodiment, the roller moving portion 341 rotates the second rod 195b around the rotation shaft 197b to switch the heating portion 84 between the first position and the second position.

The heating portion 84 of the present embodiment is configured such that the first rotating body 181 and the second rotating body 182 can be rotationally driven at the second position. The sheet manufacturing apparatus 100 according to the present embodiment is provided with the drive portion that rotationally drives the first rotating body 181, and a transmission mechanism transmitting the drive force by the drive portion to the second rotating body 182 at the second position without transmitting the drive force by the drive portion to the second rotating body 182 at the first position. For example, the drive portion is the heating portion drive motor 337 (FIG. 8). In addition, as the transmission mechanism, a link or a gear that transmits the drive force of the heating portion drive motor 337 to the first rotating body 181 or the second rotating body 182 can be used.

3. Composition of Additive Supply Portion

FIG. 7 is a schematic view illustrating a configuration of the additive supply portion 52.

The additive supply portion 52 is provided with the additive cartridge 501 as an additive accommodation portion accommodating the additive containing the resin. The additive cartridge 501 is formed in a box shape having a hollow inside, and is attached to the top of the discharge portion 52a of the additive supply portion 52. In the state where the additive cartridge 501 is attached, the discharge portion 52a communicates with the internal space of the additive cartridge 501, and the additive in the additive cartridge 501 flows down to the discharge portion 52a.

The discharge portion 52a is coupled to the tube 54 via a supply tube 52c, and the additive flows from the discharge portion 52a to the tube 54. A supply adjustment portion 52b is disposed between the discharge portion 52a and the supply tube 52c. The supply adjustment portion 52b is a mechanism that adjusts the amount of additive flowing from the discharge portion 52a into the supply tube 52c. For example, the supply adjustment portion 52b can be configured to include a shutter (not illustrated) that stops the inflow of the additive from the discharge portion 52a to the supply tube 52c, and a screw feeder (not illustrated) that feeds the additive from the discharge portion 52a to the supply tube 52c with the shutter open, and the like. In addition, the supply adjustment portion 52b may be provided with a mechanism adjusting the opening degree of the shutter.

A plurality of additive cartridges 501 can be attached to the additive supply portion 52, and the discharge portion 52a, the supply adjustment portion 52b, and the supply tube 52c are provided corresponding to the respective additive cartridges 501. In the present embodiment, seven additive cartridges 501 can be attached to the additive supply portion 52. The type of additive contained in each of the additive cartridges 501 is predetermined. For example, each of a yellow additive, a magenta additive, and a cyan additive can be supplied from the additive supply portion 52 to the tube 54 by attaching the additive cartridge 501 containing the different color additives, respectively. In addition, an additive cartridge 501 containing a white additive, a colorless (plain) additive, and the like may be attached, or an additive cartridge 501 containing an additive of another color may be attached.

The additive supply portion 52 can supply an additive from any one or more of the additive cartridges 501 among the plurality of additive cartridges 501 attached to the additive supply portion 52. For example, the control device 110 controls the additive supply portion 52, to supply the additive from the additive cartridge 501 containing the yellow additive and the additive cartridge 501 containing the cyan additive. Therefore, a green sheet S can be manufactured.

4. Control System Configuration

FIG. 8 is a block diagram illustrating a configuration of a control system of the sheet manufacturing apparatus 100.

The control device 110 provided in the sheet manufacturing apparatus 100 includes a main processor 111 that controls each part of the sheet manufacturing apparatus 100. The control device 110 is provided with a read only memory (ROM) 112 and a random access memory (RAM) 113 coupled to the main processor 111. The main processor 111 is an arithmetic processing unit such as a central processing unit (CPU), and controls each part of the sheet manufacturing apparatus 100 by executing a basic control program stored in the ROM 112. The main processor 111 may be configured as a system chip including peripheral circuits such as the ROM 112 and the RAM 113, and other IP cores.

The ROM 112 stores programs executed by the main processor 111 in a non-volatile manner. The RAM 113 forms a work area used by the main processor 111, and temporarily stores programs to be executed by the main processor 111 and data to be processed.

The non-volatile storage portion 120 stores programs executed by the main processor 111 and data processed by the main processor 111.

A display panel 116 is a display panel such as a liquid crystal display, and is installed in front of a casing (main body, not illustrated) of the sheet manufacturing apparatus 100, for example. The display panel 116 displays the operation state of the sheet manufacturing apparatus 100, various setting values, a warning display, and the like according to the control of the main processor 111.

A touch sensor 117 detects a touch (contact) operation or a pressing operation. For example, the touch sensor 117 is a pressure sensing type or capacitance type sensor having a transparent electrode, and is disposed so as to overlap the display surface of the display panel 116. When the touch sensor 117 detects an operation, the touch sensor 117 outputs operation data including the operation position and the number of the operation positions to the main processor 111. The main processor 111 detects an operation on the display panel 116 by the output of the touch sensor 117, and acquires an operation position. The main processor 111 realizes a graphical user interface (GUI) operation based on the operation position detected by the touch sensor 117 and display data 122 being displayed on the display panel 116.

The control device 110 is coupled to sensors installed in each part of the sheet manufacturing apparatus 100 via a sensor interface (I/F) 114. The sensor I/F 114 is an interface obtaining a detection value output from the sensor and inputting the detection value to the main processor 111. The sensor I/F 114 may be provided with an analog/digital (A/D) converter that converts an analog signal output from the sensor into digital data. In addition, the sensor I/F 114 may supply drive current to each sensor. In addition, the sensor I/F 114 may be provided with a circuit that acquires the output value of each sensor according to the sampling frequency specified by the main processor 111 and outputs the output value to the main processor 111.

A waste sheet remaining amount sensor 301, an additive remaining amount sensor 302, a sheet discharge sensor 303, a water amount sensor 304, an air volume sensor 306, an air velocity sensor 307, and a temperature sensor 309 are coupled to the sensor I/F 114.

The waste sheet remaining amount sensor 301 is a sensor that detects the remaining amount of the raw material MA accumulated in each stacker 11 of the supply portion 10. The control device 110 can detect the presence or absence of the remaining amount of waste sheet accommodated in each stacker 11 based on the detection value of the waste sheet remaining amount sensor 301. In addition, the remaining sheet amount sensor 301 may include a sensor that detects the amount of the raw material MA placed on the placement table 1101 (FIG. 2). That is, the remaining sheet amount sensor 301 may be a unit including a plurality of sensors, and may be configured to detect the remaining amount of the raw material MA in the plurality of stackers 11 and the placement table 1101.

The additive remaining amount sensor 302 is a sensor that detects the remaining amount of the additive which can be supplied from the additive supply portion 52, and may be configured to be able to detect the remaining amount of the additive contained in each of the plurality of additive cartridges 501. The control device 110 can obtain the remaining amount of the additive in each additive cartridge 501, or can determine whether or not the remaining amount of the additive is a threshold value or greater, based on the detection value of the additive remaining amount sensor 302.

The discharge sensor 303 detects the amount of sheets S accumulated in the tray or stacker of the discharge portion 96. The control device 110 can perform notification when it is determined that the amount of the sheet S accumulated in the discharge portion 96 is the set value or greater, based on the detection value of the sheet discharge sensor 303, for example.

The water amount sensor 304 is a sensor that detects the water amount of a water supply tank (not illustrated) built in the sheet manufacturing apparatus 100. The control device 110 performs a notification when the water amount detected by the water amount sensor 304 lowers below the set value. In addition, the water amount sensor 304 may be configured to be able to detect the remaining amount of the tank (not illustrated) of a vaporization type humidifier 343 and/or a mist type humidifier 347.

The air volume sensor 306 detects the air volume of the air flowing inside the sheet manufacturing apparatus 100. In addition, the air velocity sensor 307 detects the air velocity of the air flowing inside the sheet manufacturing apparatus 100. The control device 110 can determine the state of the air flow (material transport air flow) inside the sheet manufacturing apparatus 100 based on the detection values of the air volume sensor 306 and the air velocity sensor 307. Based on the determination result, the control device 110 can appropriately maintain the state of the air flow inside the sheet manufacturing apparatus 100 by controlling the rotation speed of the defibrating portion blower 26, the mixing blower 56, and the like.

The temperature sensor 309 is a sensor that detects the temperature of the heating roller 86 provided in the heating portion 84. The control device 110 detects the temperature of the heating roller 86, that is, the heating temperature at which the second web W2 is heated by the heating roller 86, based on the detection value of the temperature sensor 309.

The color measurement portion 391 is a measuring device that measures the color of the raw material MA as illustrated in FIG. 2. The color measurement portion 391 is coupled to the sensor I/F 114, and outputs an output value indicating the detection result to the sensor I/F 114.

The scanner 393 optically reads the raw material MA as illustrated in FIG. 2 and outputs the read image to the sensor I/F 114.

The control device 110 is coupled to each drive portion provided in the sheet manufacturing apparatus 100 via a drive portion I/F 115. A motor, a pump, a heater, and the like provided in the sheet manufacturing apparatus 100 are coupled to the drive portion I/F 115. Although these are generically called a drive portion, in particular, a portion that causes physical displacement, such as a motor, can be used as a drive portion, and another portion such as heater can also be referred to as an operation portion. In the following description, the drive portion includes a drive portion and an operation portion that are coupled to the drive portion I/F 115 and perform functions according to the control of the control device 110.

The drive portion I/F 115 may be coupled to each drive portion described above via a drive integrated circuit (IC). For example, the drive IC is a circuit that supplies a drive current to the drive portion according to the control of the main processor 111, and is configured to include a power semiconductor element or the like. For example, the drive IC may be an inverter circuit or a drive circuit for driving a stepping motor, and the specific configuration and specifications thereof may be appropriately selected in accordance with the coupled drive portion.

A coarse crushing portion drive motor 311 is coupled to the drive portion I/F 115, and rotates a cutting blade (not illustrated) that cuts the raw material MA according to the control of the control device 110.

A defibrating portion drive motor 313 is coupled to the drive portion I/F 115 and rotates a rotor (not illustrated) provided in the defibrating portion 20 according to the control of the control device 110.

A sheet feeding motor 315 drives the supply roller 1111 and the supply roller 1112 provided in the supply portion 10, and the feed roller 11a provided in each stacker 11. The sheet feeding motor 315 may be a unit including a plurality of motors. The sheet feeding motor 315 transports the raw material MA in the supply portion 10 according to the control of the control device 110.

The raw material distribution portion 397 is coupled to the drive portion I/F 115. The raw material distribution portion 397 individually slides and moves each of the stackers 11 provided in the supply portion 10 according to the control of the control device 110. The raw material MA is supplied from the transport path 1102 to the stacker 11 moved to the transport path 1102 side by the raw material distribution portion 397.

An additive supply motor 317 is coupled to the drive portion I/F 115, and drives a screw feeder (not illustrated) that feeds the additive in the supply adjustment portion 52b according to the control of the control device 110. The additive supply motor 317 may be a motor that opens and closes a shutter of the supply adjustment portion 52b.

The defibrating portion blower 26 is coupled to the drive portion I/F 115. Similarly, the mixing blower 56, the suction blower 77, the intermediate blower 318, and the collection blower 28 are coupled to the drive portion I/F 115 in the drive portion I/F 115. With this configuration, the control device 110 can control the start and stop of the defibrating portion blower 26, the mixing blower 56, the suction blower 77, the intermediate blower 318, and the collection blower 28. The intermediate blower 318 is a blower that performs suction from the suction mechanism 79c of the transport portion 79. The control device 110 may control start/stop of suction by each of these blowers, and may be configured to be able to control the number of rotation speed of each blower.

In addition, a drum drive motor 325, a belt drive motor 327, a dividing portion drive motor 329, a drum drive motor 331, a belt drive motor 333, the pressurizing portion drive motor 335, and the heating portion drive motor 337 are coupled to the drive portion I/F 115 includes.

The drum drive motor 325 is a motor that rotates the drum portion 41. The belt drive motor 327 is a motor that operates the mesh belt 46 of the first web forming portion 45. The dividing portion drive motor 329 is a motor that rotates the rotating body 49. The drum drive motor 331 is a motor that rotates the drum portion 61. The belt drive motor 333 is a motor that drives the mesh belt 72. In addition, the pressurizing portion drive motor 335 is a motor that drives the calender roller 85 of the pressurizing portion 82. The heating portion drive motor 337 is a motor that drives the heating roller 86 of the heating portion 84.

The control device 110 controls ON/OFF of each of these motors. In addition, the control device 110 may be configured to be able to control the number of rotation speed of each of the motors described above.

A heater 339 is a heater that heats the heating roller 86, and corresponds to the heat source H illustrated in FIG. 3. The heater 339 is coupled to the drive portion I/F 115, and the control device 110 controls ON/OFF of the heater 339. In addition, the heater 339 may be configured to be able to switch the output, and the control device 110 may be configured to be able to control the output of the heater 339.

The roller moving portion 341 operates the displacement mechanism 190 (FIGS. 5 and 6) provided in the heating portion 84 to displace the heating portion 84 to the first position of FIG. 5 and the second position of FIG. 6. The roller moving portion 341 is coupled to the control device 110 via the drive portion I/F 115, and the control device 110 controls the roller moving portion 341 to switch between the first position and the second position of the heating portion 84.

The vaporization type humidifier 343 is a device that is provided with a tank (not illustrated) storing water, and a filter (not illustrated) being infiltrated with the water of the tank, and blows and humidifies the filter. The vaporization type humidifier 343 includes a fan (not illustrated) coupled to the drive portion I/F 115, and turns ON/OFF air blowing to the filter according to the control of the control device 110. In the present embodiment, the humidified air is supplied from the vaporization type humidifier 343 to the humidifying portions 202, 204, 206, and 208. Therefore, the humidifying portions 202, 204, 206, and 208 supply the humidified air supplied by the vaporization type humidifier 343 to the coarse crushing portion 12, the sorting portion 40, the tube 54, and the accumulating portion 60. In addition, the vaporization type humidifier 343 may be configured to include a plurality of vaporization type humidifiers. In this case, the installation place of each vaporization type humidifier may be any of the coarse crushing portion 12, the sorting portion 40, the tube 54, and the accumulating portion 60.

In addition, the vaporization type humidifier 343 is provided with a humidifying heater 345 heating the air blown to a filter by a fan. The humidifying heater 345 is coupled to the drive portion I/F 115 separately from the fan (not illustrated) provided in the vaporization type humidifier 343. The control device 110 controls ON/OFF of the fan provided in the vaporization type humidifier 343 and controls ON/OFF of the humidifying heater 345 independently of the control of the vaporization type humidifier 343. The vaporization type humidifier 343 corresponds to a humidifier of the present invention, and the humidifying heater 345 corresponds to a heat source.

The mist type humidifier 347 is provided with a tank (not illustrated) storing water, and a vibration portion (not illustrated) vibrating the water of the tank to generate mist-like water droplets (mist). The mist type humidifier 347 is coupled to the drive portion I/F 115, and turns ON/OFF the vibration portion according to the control of the control portion 150. In the present embodiment, air containing mist is supplied from the mist type humidifier 347 to the humidifying portions 210 and 212. Therefore, the humidifying portions 210 and 212 supply air including mist supplied by the mist type humidifier 347 to each of the first web W1 and the second web W2.

A water supply pump 349 is a pump that sucks water from the outside of the sheet manufacturing apparatus 100 and takes water into a tank (not illustrated) provided inside the sheet manufacturing apparatus 100. For example, when the sheet manufacturing apparatus 100 is started, an operator operating the sheet manufacturing apparatus 100 puts water in a water supply tank and sets the water supply tank. The sheet manufacturing apparatus 100 operates the water supply pump 349 to take water from the water supply tank into the tank inside the sheet manufacturing apparatus 100. In addition, the water supply pump 349 may supply water from the tank of the sheet manufacturing apparatus 100 to the vaporization type humidifier 343 and the mist type humidifier 347.

A cutting portion drive motor 351 is a motor that drives the first cutting portion 92 and the second cutting portion 94 of the cutting portion 90. The cutting portion drive motor 351 is coupled to the drive portion I/F 115.

In addition, an IC reader 119 is coupled to the control device 110. The IC reader 119 performs data reading and writing on an IC 521 provided in each of the additive cartridges 501 (FIG. 7) attached to the additive supply portion 52.

The IC 521 is attached to each of the additive cartridges 501. The IC 521 is an IC chip provided with a storage area for storing data, and stores data regarding the additive contained in the additive cartridge 501. The IC 521 may be a contact IC chip or a non-contact IC chip (for example, radio frequency identifier (RFID)).

The data stored in the IC 521 includes data on the additives contained in the additive cartridge 501. For example, the color, properties, suitable heating temperature and the like of the additive contained in the additive cartridge 501 may be included, and a code corresponding to these data may be included. In the present embodiment, the IC 521 stores type data 521a, temperature data 521b (heating temperature information), and remaining amount data 521c. The type data 521a includes data indicating the type of additive contained in the additive cartridge 501, and indicates the color of the additive, for example. The temperature data 521b includes data indicating a heating temperature suitable for the additive contained in the additive cartridge 501. The remaining amount data 521c includes data indicating the remaining amount of the additive in the additive cartridge 501. The remaining amount data 521c can be written and updated by the IC reader 119. In addition, the IC 521 may store identification information unique to each IC 521.

The IC reader 119 is a device that reads data stored in the IC 521 and writes (including erasing) data on the IC 521, and is a contact type or non-contact type IC reader/writer, for example. For example, a plurality of IC readers 119 may be installed corresponding to the number of additive cartridges 501 that can be attached to the additive supply portion 52. The IC reader 119 reads data from each of the plurality of ICs 521 attached to each additive cartridge 501 and outputs the read data to the control device 110 according to the control of the control device 110.

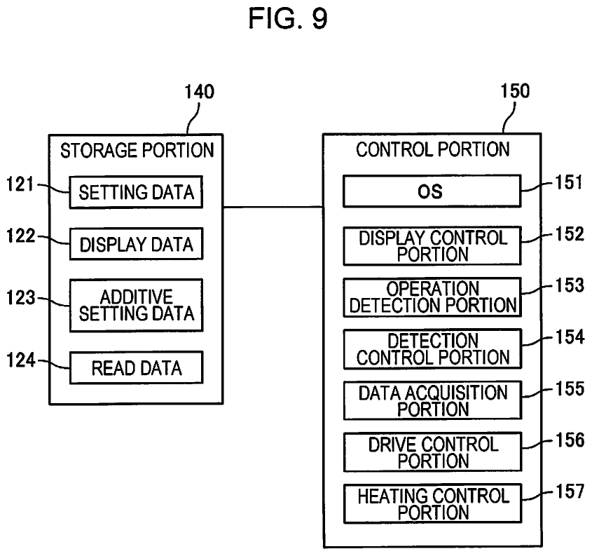

FIG. 9 is a functional block diagram of the sheet manufacturing apparatus 100, illustrating a functional configuration of a storage portion 140 and a control portion 150. The storage portion 140 is a logical storage portion configured to include the non-volatile storage portion 120 (FIG. 8).

The control portion 150 and various functional portions included in the control portion 150 are formed by the cooperation of software and hardware when the main processor 111 executes a program. Examples of hardware that configures these functional portions include the main processor 111 and the non-volatile storage portion 120.

The storage portion 140 stores setting data 121, display data 122, additive setting data 123, and read data 124.

The setting data 121 includes data for setting the operation of the sheet manufacturing apparatus 100. For example, the setting data 121 includes data such as the characteristics of various sensors provided in the sheet manufacturing apparatus 100, and a threshold used in the treatment in which the main processor 111 detects an abnormality based on detection values of the various sensors.

The display data 122 is data of a screen that the main processor 111 causes the display panel 116 to display. The display data 122 may be fixed image data, or may be data for setting a screen display displaying data generated or acquired by the main processor 111.

The additive setting data 123, is data that is referred to when the control portion 150 sets the type and amount of the additive added by the additive supply portion 52.

The read data 124 is data read from the IC 521 by the IC reader 119. The read data 124 may include data read from the plurality of ICs 521.

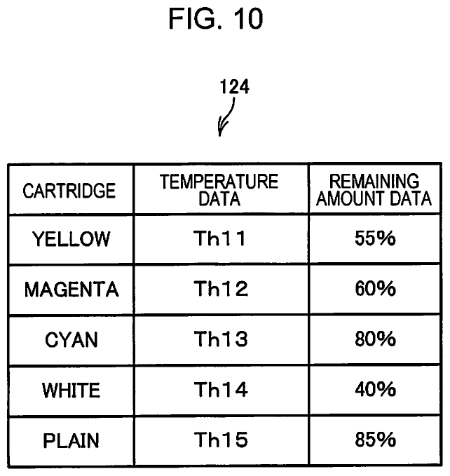

FIG. 10 is a schematic view illustrating a configuration example of the read data 124.

In the example illustrated in FIG. 10, the read data 124 includes type data, temperature data, and remaining amount data. The type data is data obtained by reading the type data 521a stored on the IC 521 by the IC reader 119. The temperature data of the read data 124 is temperature data 521b. In addition, the remaining amount data is data obtained by reading the remaining amount data 521c.

The control portion 150 causes the IC reader 119 to detect the presence or absence of the IC 521 when the additive cartridge 501 is attached or when the sheet manufacturing apparatus 100 is powered on. The control portion 150 reads the type data 521a, the temperature data 521b, and the remaining amount data 521c from the detected IC 521, and stores the read data as the read data 124 in the storage portion 140. The read data 124 may include identification information for identifying the IC 521 in association with type data, temperature data, and remaining amount data. For example, the identification information of the IC 521 is an ID unique to the IC 521, is stored in the storage area of the IC 521, and can be read by the IC reader 119 with the type data 521a.

The control portion 150 can update and edit the read data 124 stored in the storage portion 140. That is, when the sheet manufacturing apparatus 100 manufactures the sheet S and the additive inside the additive cartridge 501 is consumed and decreased, the control portion 150 may update the remaining amount data of the read data 124 so as to reflect this decrease.

The control portion 150 may overwrite the remaining amount data 521c of the IC 521 with the remaining amount data of the read data 124 stored in the storage portion 140, when performing a treatment of removing the additive cartridge 501 or in a stop sequence of the sheet manufacturing apparatus 100. In addition, the control portion 150 may perform a treatment to overwrite the remaining amount data 521c based on the remaining amount data included in the read data 124 at a predetermined timing at a predetermined timing, during operation of the sheet manufacturing apparatus 100 (including other than during manufacture of the sheet S).

The type data of the read data 124 indicates the type of additive contained in the additive cartridge 501, and the additive cartridge 501 is distinguished by the color in the example of FIG. 10. The additives are not limited to colored, and the plain additive cartridge 501 contains colorless or nearly colorless colored additives for example.

As temperature data, Th11 to Th15 indicating temperatures suitable for the respective additive cartridges 501 are set. Th11, Th12, Th13, Th14, and Th15 are numerical values or codes indicating the specific temperature or the range of the temperature, respectively. These temperatures are the temperature set at the heating portion 84 so as to melt the resin contained in each of the additives in an appropriate state, adhere the fibers with a desired strength, and obtain good color development. The temperature data included in the read data 124 may be either the temperature data 521b itself or data obtained by converting the temperature data 521b into the heating temperature of the heating portion 84, and the specific data format and the like are predetermined.

The control portion 150 sets the heating temperature of the heating portion 84 based on the temperature data of the read data 124 corresponding to the additive cartridge 501 containing the additive used for manufacturing the sheet S, as described later. As a result, the second web W2 can be heated at an appropriate temperature in the heating portion 84, the additives contained in the second web W2 can be sufficiently melted, and a high quality sheet S can be manufactured. Although the specific temperature of Th11 to Th15 varies depending on the specific properties of the additive, since there is practically no melting of the additive at temperatures close to room temperature, the specific temperature is higher than the so-called room temperature. For example, temperatures exceeding 100 degrees Celsius are not uncommon.

The control portion 150 has functions of an operating system (OS) 151, a display control portion 152, an operation detection portion 153, a detection control portion 154, a data acquisition portion 155, a drive control portion 156, and a heating control portion 157.

The function of the operating system 151 is a function of a control program stored in the storage portion 140, and each part of the control portion 150 is a function of an application program executed on the operating system 151.

The display control portion 152 causes the display panel 116 to display an image based on the display data 122.

The operation detection portion 153 determines the content of the GUI operation corresponding to the detected operation position when the operation on the touch sensor 117 is detected.

The detection control portion 154 acquires detection values of various sensors coupled to the sensor I/F 114. In addition, the detection control portion 154 determines the detection value of the sensor coupled to the sensor I/F 114 in comparison with a preset threshold value (setting value). When the determination result corresponds to the condition for performing notification, the detection control portion 154 outputs the notification content to the display control portion 152, and causes the display control portion 152 to perform notification using an image or text.

The data acquisition portion 155 causes the IC reader 119 to read data from the IC 521.

The drive control portion 156 controls start (activation) and stop of each drive portion coupled via the drive portion I/F 115. In addition, the drive control portion 156 may be configured to control the rotation speed of the defibrating portion blower 26, the mixing blower 56, and the like.

The heating control portion 157 controls the temperature at which the second web W2 is heated by the heating roller 86 of the heating portion 84. The heating control portion 157 sets the heating temperature by the heating portion 84. Here, the temperature set by the heating control portion 157 can be referred to as a target temperature to be a target of control. The heating control portion 157 acquires the detection value of the temperature sensor 309 and controls the heater 339 so that the heating temperature of the heating portion 84 is the set target temperature.

The accuracy of the temperature control performed by the heating control portion 157 may be set to a level that can satisfy the quality of the sheet S. Specifically, the heating control portion 157 maintains the temperature of the heating roller 86 within a predetermined temperature range including the set target temperature by switching ON/OFF the heater 339 and/or controlling the output of the heater 339. The magnitude of the predetermined temperature range and the difference from the target temperature are appropriately set. For example, the setting method and conditions of the predetermined temperature range with respect to the target temperature may be included in the setting data 121 and stored in the storage portion 140, and the heating control portion 157 may perform control according to the setting. In addition, the heating control portion 157 may control ON/OFF of the humidifying heater 345.

5. Operation of Sheet Manufacturing Apparatus

Subsequently, the operation of the sheet manufacturing apparatus 100 will be described.

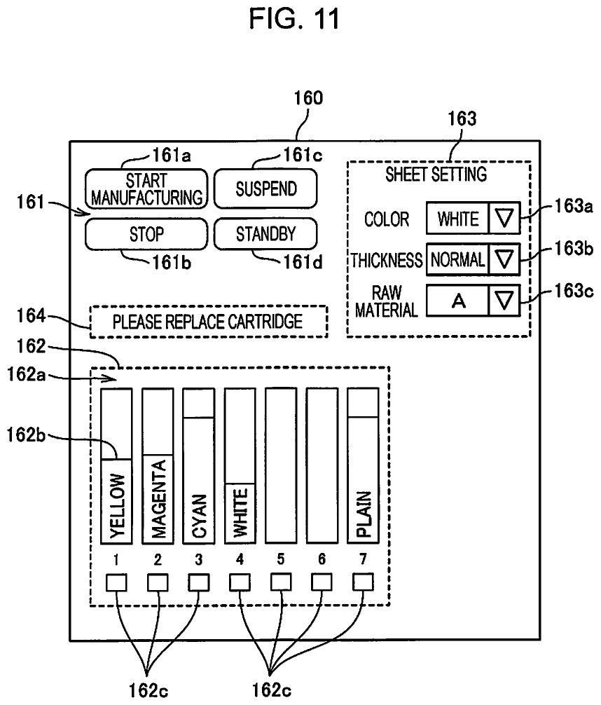

FIG. 11 is a diagram illustrating an example of a screen displayed by the display panel 116, and illustrates an operation screen 160 for a user (operator) operating the sheet manufacturing apparatus 100 to operate.

The operation screen 160 of FIG. 11 may be displayed by the display panel 116 after the sheet manufacturing apparatus 100 is powered on, and may be continuously displayed while the sheet manufacturing apparatus 100 manufactures the sheet S or in a second state described later.

On the operation screen 160, an operation instruction portion 161, a cartridge information display portion 162, a sheet setting portion 163, and a notification portion 164 are disposed. The operation instruction portion 161, the cartridge information display portion 162, and the sheet setting portion 163 constitute a GUI for the user to operate. By displaying the operation screen 160 on the display panel 116, the touch sensor 117 and the operation detection portion 153 (FIG. 9) constitute a reception portion.

The operation instruction portion 161 includes a start instruction button 161a, a stop instruction button 161b, an suspend instruction button 161c, and a standby instruction button 161d, which function as buttons (operation portions) for instructing the operation of the sheet manufacturing apparatus 100.

The sheet setting portion 163 includes a color setting portion 163a, a thickness setting portion 163b, and a raw material setting portion 163c, which function as buttons (operation portions) for instructing the conditions of the sheet S manufactured by the sheet manufacturing apparatus 100.

Each operation portion disposed in the operation instruction portion 161 and the sheet setting portion 163 may be installed in the casing of the sheet manufacturing apparatus 100 as a physical button. In the present embodiment, as an example, an example in which the above-described operation portions are provided as a GUI (icon) by the display panel 116 and the touch sensor 117 will be described.

The color setting portion 163a is an operation portion for specifying the color of the sheet S. In the example of FIG. 11, when the user operates the color setting portion 163a, the color of the sheet S can be selected from a plurality of colors set in advance by the pull-down menu. The control portion 150 causes the operation detection portion 153 to acquire the color selected by the operation of the color setting portion 163a.

The colors selectable by the color setting portion 163a may be set corresponding to the additive cartridge 501 attached to the additive supply portion 52. For example, when the additive supply portion 52 is attached with the additive cartridge 501 containing a white additive and the additive cartridge 501 containing a plain (colorless) additive, the color setting portion 163a includes a configuration in which “white” and “gray” can be selected.

The drive control portion 156 determines the type of additive to be used and the ratio of each additive when using a plurality of types of the additives among the additives of the additive cartridge 501 attached to the additive supply portion 52 corresponding to the selected color. The drive control portion 156 determines the amount of additive supplied from each of the additive cartridges 501 based on the type of additive to be used and the ratio of each additive when using the plurality of types of the additives, and controls the additive supply motor 317 based on the determined amount. For example, when “white” is selected in the color setting portion 163a, the drive control portion 156 sets the additive cartridge 501 containing the white additive as a supply source. When “gray” is selected, the additive cartridge 501 containing plain additives is set as a supply source.

The thickness setting portion 163b is an operation portion for specifying the thickness of the sheet S. In the example of FIG. 11, when the user operates the thickness setting portion 163b, the thickness of the sheet S can be selected from the thickness of a plurality of levels set in advance by the pull-down menu. The control portion 150 causes the operation detection portion 153 to acquire the thickness selected by the operation of the thickness setting portion 163b. The drive control portion 156 determines the conditions such as the thickness of the second web W2 accumulated on the mesh belt 72 in the accumulating portion 60 and/or the load applied to the second web W2 by the pressurizing portion 82 corresponding to the selected thickness. The drive control portion 156 controls the rotational speed of the drum drive motor 331, the rotational speed of the belt drive motor 333, an operation condition of the pressurizing portion drive motor 335, and the like corresponding to the determined condition.

The raw material setting portion 163c is an operation portion for specifying the raw material MA used for manufacturing the sheet S. In the example of FIG. 11, when the user operates the raw material setting portion 163c, the type of the raw material MA of the sheet S can be selected from a plurality of types set in advance by the pull-down menu. The raw material MA that can be selected by the raw material setting portion 163c is a raw material MA that the supply portion 10 accommodates in the stacker 11. That is, the selection in the raw material setting portion 163c corresponds to the selection of the stacker 11 that feeds the raw material MA in the supply portion 10. The control portion 150 causes the operation detection portion 153 to acquire the type of the raw material MA selected by the operation of the raw material setting portion 163c. The drive control portion 156 selects the stacker 11 that accommodates the selected type of raw material MA, and controls the sheet feeding motor 315 so that the raw material MA is supplied from the selected stacker 11.

In addition, in the sheet setting portion 163, in addition to the above-described buttons, a button for specifying the number of sheets S to be manufactured or a button for specifying the size (dimension) of the sheet S may be disposed, and a button for specifying a condition related to the other sheet S may be disposed.

The start instruction button 161a is a button for instructing the start of the manufacture of the sheet S. For example, the start instruction button 161a is operated after the condition related to the sheet S is specified by the operation of the sheet setting portion 163, and instructs start of the manufacture of the sheet S based on the specified condition. In the sheet setting portion 163, when a default specified value is provided in advance, and the start instruction button 161a is operated in a state where the sheet setting portion 163 is not operated, the sheet manufacturing apparatus 100 may start the manufacture of the sheet S based on the default specified value.

The stop instruction button 161b is a button for instructing stop of the operation of the sheet manufacturing apparatus 100. The casing of the sheet manufacturing apparatus 100 may be provided with a power switch (not illustrated) for turning ON/OFF the power of the sheet manufacturing apparatus 100 separately from the display panel 116. In this case, the stop instruction button 161b functions as a button for instructing to stop the sheet manufacturing apparatus 100. However, the stop instruction button 161b may be configured to be capable of instructing to turn off the sheet manufacturing apparatus 100. When the sheet manufacturing apparatus 100 stops the manufacture of the sheet S by the operation of the stop instruction button 161b, the condition related to the sheet S set by the sheet setting portion 163 is cleared and returns to the default specified value (initial value).

The suspend instruction button 161c temporarily suspends the manufacture of the sheet S while the sheet manufacturing apparatus 100 performs the manufacture of the sheet S. When the suspend instruction button 161c is operated and the sheet manufacturing apparatus 100 stops the manufacture of the sheet S, the condition related to the sheet S set by the sheet setting portion 163 is maintained. In this state, when the start instruction button 161a is operated, the control portion 150 starts (resumes) the manufacture of the sheet S in accordance with the same conditions as those before the suspend instruction button 161c is operated by the sheet manufacturing apparatus 100.

The standby instruction button 161d is a button for instructing transition to the second state described later in a state where the sheet manufacturing apparatus 100 is not manufacturing the sheet S, that is, in a stopped state.

A series of operations for manufacturing the sheet S by the sheet manufacturing apparatus 100 will be referred to as “job”. The job refers to an operation of manufacturing the sheet S under the condition specified by the operation of the sheet setting portion 163 or the default value. Specifically, the operation from the start of the operation in response to the operation to complete the manufacture of the number of sheets S specified by the operation of the sheet setting portion 163, or to the operation of the start instruction button 161a to the stop by the operation of the stop instruction button 161b is called the job. When the number of sheets S to be manufactured is specified, the end of the job is clearly specified. When the stop instruction button 161b is operated without specifying the number of sheets S, or when the stop instruction button 161b is operated before completing the manufacture of the specified number of sheets S, there is no prior setting, but the job ends. When the suspend instruction button 161c is operated, the sheet manufacturing apparatus 100 suspends the job, but does not end the job. Therefore, when the manufacture of the sheet S is stopped in response to the operation of the suspend instruction button 161c, and the start instruction button 161a is operated, the sheet manufacturing apparatus 100 resumes the manufacture of the sheet S, and specifically, manufactures the sheet S under the same conditions as before the operation of the suspend instruction button 161c. That is, the suspend instruction button 161c temporarily suspends the job, and thereafter, when the start instruction button 161a is operated, the job continues.

The cartridge information display portion 162 is a display portion that displays information on the additive cartridge 501 attached (set) to the additive supply portion 52.

On the cartridge information display portion 162, a cartridge image 162a imitating the additive cartridge 501 is displayed corresponding to the number of the additive cartridges 501 that can be attached to the additive supply portion 52. On the cartridge image 162a, a character string indicating the type (for example, color) of the additive and a remaining amount gauge 162b indicating the remaining amount of the additive are displayed. In addition, when the number of the additive cartridges 501 attached to the additive supply portion 52 is smaller than the attachable number, the cartridge image 162a corresponding to the additive cartridge 501 not attached is displayed blank.

Furthermore, on the cartridge information display portion 162, a cartridge selection portion 162c is disposed corresponding to each cartridge image 162a.

The cartridge selection portion 162c functions as a display portion that displays the additive cartridge 501 containing the additive selected as the additive used for manufacturing the sheet S. In addition, the cartridge selection portion 162c also functions as an operation portion specifying an additive used for manufacturing the sheet S by the operation of the user. In the cartridge selection portion 162c corresponding to the additive cartridge 501 selected by the operation of the user or the treatment performed by the control portion 150, a symbol indicating that the additive cartridge 501 is selected is displayed.

The notification portion 164 is a display area where the content to be notified to the user is displayed by text or an image. For example, the notification portion 164 displays a message for requesting replacement of the additive cartridge 501.

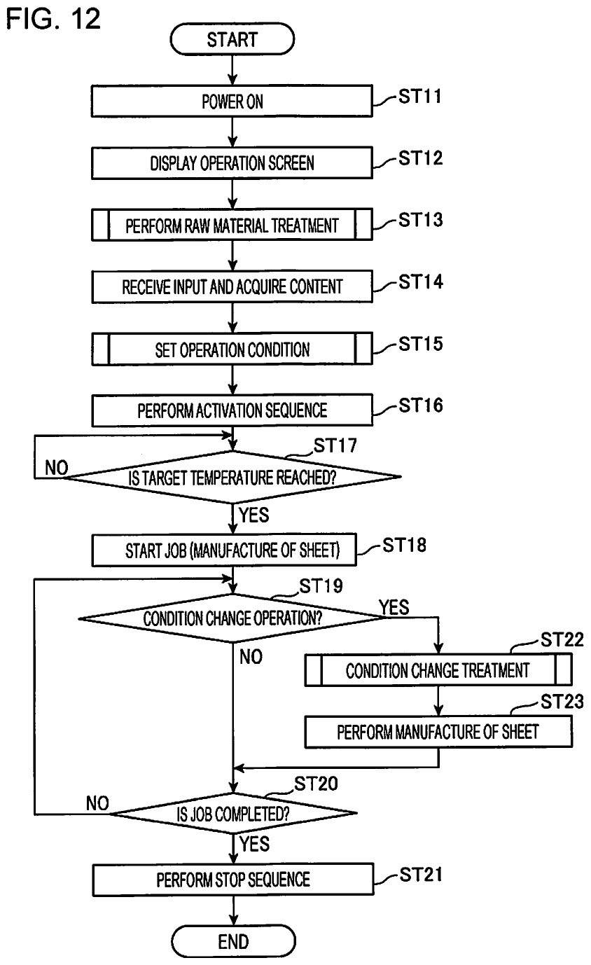

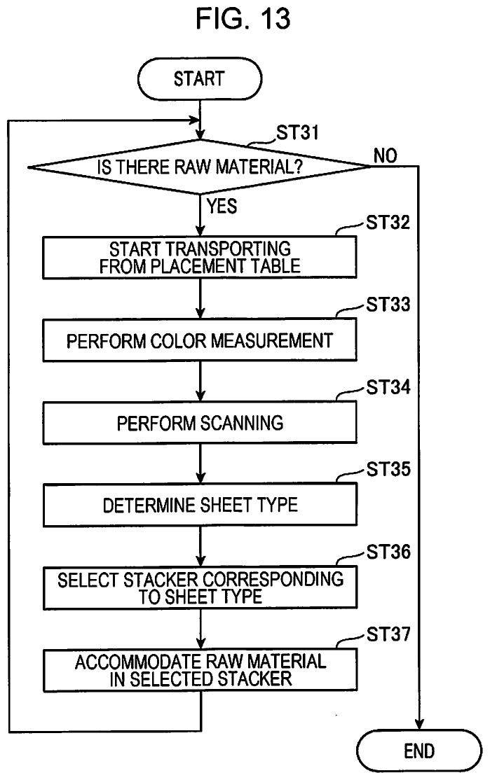

FIG. 12 is a flowchart illustrating an operation of the sheet manufacturing apparatus 100. FIGS. 13, 15, 17, 18, and 19 are flowcharts illustrating the operations of the sheet manufacturing apparatus 100, and in particular, illustrate the treatment of FIG. 12 in detail.

When the sheet manufacturing apparatus 100 is powered on (Step ST11), the display control portion 152 causes the display panel 116 to display the operation screen 160 (Step ST12).

Here, the control portion 150 performs a raw material treatment of distributing the raw material MA to the stacker 11 by the supply portion 10.

FIG. 13 is a flowchart illustrating an operation of the sheet manufacturing apparatus 100, and in particular illustrates the raw material treatment in detail.

The control portion 150 determines the presence or absence of the raw material MA placed on the placement table 1101 by the waste sheet remaining amount sensor 301 (Step ST31). When it is determined that the raw material MA is not present (Step ST31; No), the control portion 150 ends the raw material treatment.

When it is determined that the raw material MA is present on the placement table 1101 (Step ST31; Yes), the control portion 150 causes the supply roller 1111 to transport the raw material MA from the placement table 1101 to the transport path 1102 (Step ST32).

While the raw material MA is transported through the transport path 1102, the color measurement portion 391 performs color measurement of the surface of the raw material MA under the control of the control portion 150 (Step ST33), and the scanner 393 scans the raw material MA (Step ST34).

The control portion 150 analyzes the result of the color measurement of the color measurement portion 391 and the image scanned by the scanner 393 to determine the type (sheet type) of the raw material MA (Step ST35).

The control portion 150 selects the stacker 11 corresponding to the determined sheet type (Step ST36), operates the raw material distribution portion 397, and moves the selected stacker 11 on the transport path 1102 side (Step ST37). As a result, the raw material MA determined in Step ST35 is accommodated in the stacker 11 selected in Step ST36. Thereafter, the control portion 150 returns to Step ST31.

The control portion 150 may continuously perform the operations of Steps ST32 to ST37 of FIG. 13. That is, in a state where the raw material MA is present in the transport path 1102, the next raw material MA may be transported from the placement table 1101, and the color measurement and the scanning may be performed. In this case, a large number of raw materials MA can be distributed to the stacker 11 at higher speed.

Returning to FIG. 12, the operation detection portion 153 detects an operation on the operation screen 160 by the user, performs treatment for receiving an input by this operation, and acquires an operation content (Step ST 14).

The control portion 150 sets the operation conditions of the sheet manufacturing apparatus 100 based on the operation content acquired by the operation detection portion 153 in Step ST14 by the functions of the drive control portion 156 and the heating control portion 157 (Step ST15).

Three types of treatments are mentioned as a treatment which the control portion 150 performs in Step ST15. These treatments will be sequentially described as a first treatment, a second treatment, and a third treatment.

In the description of the first to third treatments, in the present embodiment, the type of the raw material MA is divided into the PPC sheet, the recycled sheet containing resin (resin-containing recycled sheet), and the Kraft sheet, and the PPC sheet has different types of sheets having a printing ratio of less than 20% (0 to 20%) and a sheet having a printing ratio of 20% or more. These four types of raw materials MA are accommodated separately in the stackers 11 of A to D.

The resin-containing recycled sheet is a sheet in which a sheet such as a PPC sheet is processed into the recycled sheet by the sheet manufacturing apparatus 100 or other apparatus after use, and refers to a sheet in which the resin (additive in sheet manufacturing apparatus 100) is mixed in the step of manufacturing the recycled paper. The resin-containing recycled sheet may be recycled from the recycled sheet as a raw material by the sheet manufacturing apparatus 100 or another sheet manufacturing apparatus. That is, the resin-containing recycled sheet may contain fibers and resins subjected to a plurality of times of recycling processes by the sheet manufacturing apparatus 100 or another sheet manufacturing apparatus.

In the first to third treatments, the control portion 150 sets the heating temperature of the heating portion 84 depending on the type of the raw material MA and the additive to be used. The sheet manufacturing apparatus 100 causes the heating portion 84 to melt and bond the fibers and the resin by melting the resin contained in the second web W2. The amount of heat required for melt bonding includes the magnitude relation illustrated in the following formula (11).

Resin-containing recycled sheet>PPC sheet (printing ratio of 20% or more)>PPC sheet (printing ratio of less than 20%) (11)

The resin-containing recycled sheet contains a large amount of resin in the state of the raw material MA. In addition, a large amount of coloring material including a resin such as toner adheres to the PPC sheet having a high printing ratio, and the amount of heat required for the melt bonding is large due to the influence of the resin of the coloring material.

In addition, the heat capacity differs depending on the type of raw material MA. That is, the PPC sheet and the resin-containing recycled sheet obtained by reusing the PPC sheet after use may contain additives for improving whiteness and printing quality, fillers, and auxiliary materials for sizing agents in many cases. These auxiliary materials also have the effect of increasing the amount of heat required for the melt bonding. In consideration of the viewpoint of the auxiliary material, the amount of heat required for the melt bonding includes the magnitude relation illustrated in the following formula (12).

Resin-containing recycled sheet>PPC sheet>Kraft sheet (12)

When these are put together, the relation of the following formula (13) is established for the amount of heat required for the melt bonding for each raw material MA.

Resin-containing recycled sheet>PPC sheet (printing ratio of 20% or more)>PPC sheet (printing ratio of less than 20%)>Kraft sheet (13)

The amount of heat required for the melt bonding is the amount of heat assigned to the second web W2 by the heating portion 84. Specifically, the relationship of the following formula (14) is considered.

Amount of heat=heating time×heating temperature (14)

That is, when determining the heating time in the heating portion 84 and the heating temperature of the heating portion 84, it is preferable to consider the amount of heat required for each type of the raw material MA.

In addition, as a standard of the heating temperature when heating and melting the resin in the heating portion 84, a glass transition temperature Tg of the resin, that is, the additive is mentioned. The glass transition temperature Tg indicates the meltability of the resin acting as a binding material, that is, the additive.

Therefore, when the heating temperature is determined as the condition for heating the second web W2 in the heating portion 84, it is necessary for the heating temperature not only to satisfy the required amount of heat, but also to satisfy the glass transition temperature Tg. In other words, when an additive having a low glass transition temperature Tg is used, the second web W2 can be easily melted and bonded, and the amount of heat required for the melt bonding can be compensated.

For example, when the raw material MA is the Kraft sheet, it is assumed that an additive having a glass transition temperature Tg=TgA is used, and when the raw material MA is the PPC sheet (printing ratio of less than 20%), an additive having a glass transition temperature Tg=TgB is used. In this example, when the raw material MA is the PPC paper (printing ratio of 20% or more), an additive having a glass transition temperature Tg=TgC is used, and when the raw material MA is the resin-containing recycled paper, an additive having a glass transition temperature Tg=TgD is used. In this example, the glass transition temperature Tg may be expressed by the following formula (15).

TgA>TgB>TgC>TgD (15)

When applying the relationship illustrated in the formula (15), an additive having a lower glass transition temperature Tg is used as the raw material MA (above formula (13)) has a larger amount of heat required for the melt bonding. In this case, since the glass transition temperature Tg of the additive is low, the amount of heat required for the melt bonding is low, and even when the heating temperature in the heating portion 84 is low, the melt bonding is likely to occur. Therefore, the second web W2 can be sufficiently melted and bonded without prolonging the heating time, and a high quality sheet S can be manufactured.

The first to third treatments indicate an example in which the heating temperature in the heating portion 84 is appropriately set depending on the type of the raw material MA and the additive based on the above findings.

[1] First Treatment

A first treatment is a treatment which sets different heating temperature depending on the type of raw material MA, when using one type of additive.

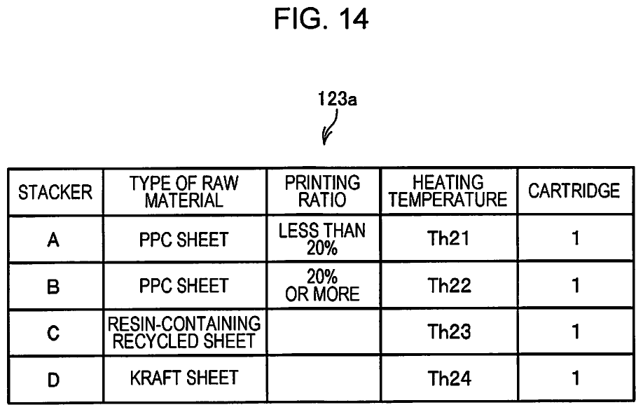

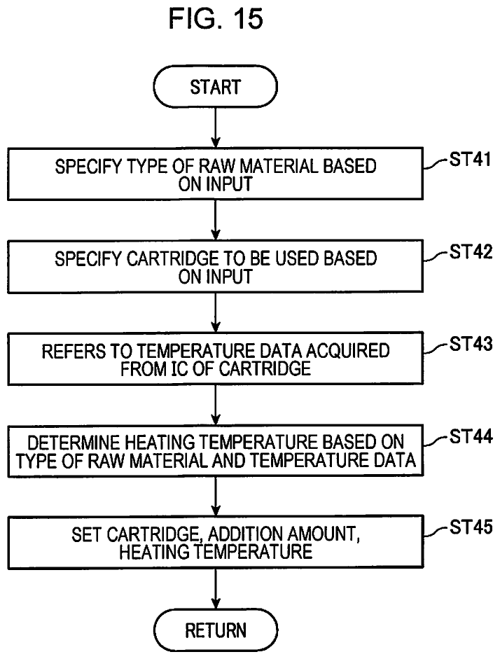

FIG. 14 is a schematic view illustrating a configuration example of the additive setting data 123a as an example of the additive setting data 123. In addition, FIG. 15 is a flowchart illustrating an operation of the sheet manufacturing apparatus 100, and illustrates the first treatment performed in Step ST15.

The additive setting data 123a illustrated in FIG. 14 includes information indicating the type of the raw material MA (sheet type), the printing ratio, the heating temperature of the heating portion 84, and the additive cartridge 501 to be used in association with each stacker 11 provided in the supply portion 10. The information indicating the additive cartridge 501 may be identification information of the IC 521.

The additive setting data 123a is the additive setting data 123 corresponding to the first treatment. Specifically, for one additive cartridge 501, the data is included that defines the setting temperature corresponding to the four types of raw materials MA.

In the example of FIG. 14, the additive setting data 123a includes the heating temperatures corresponding to four types of raw materials MA of the PPC sheet having a printing ratio of less than 20%, the PPC sheet having a printing ratio of 20% or more, the recycled sheet containing resin, and the Kraft sheet. The heating temperature is a temperature set to satisfy the amount of heat required for the melt bonding for each type of the raw material MA.

In the example of FIG. 14, the additive setting data 123a exemplifies a configuration including the heating temperature when using the additive cartridge 501 of No. 1. According to the formula (13), a relationship of the following formula (16) is established between the heating temperature Th21 of the PPC sheet (printing ratio of less than 20%), the heating temperature Th22 of the PPC sheet (printing ratio of 20% or more), the heating temperature Th23 of the resin-containing recycled sheet, and the heating temperature Th24 of the Kraft sheet.

Th23>Th22>Th21>Th24 (16)

The additive setting data 123a may be configured to include the heating temperature for each type of the raw material MA for each of the additive cartridges 501 other than No. 1. In addition, corresponding to the case where the plurality of additives are used, the heating temperature may be included for each type of the raw material MA corresponding to the combination of the plurality of additive cartridges 501.

Incidentally, the heating temperature of the heating portion 84 is determined based on the read data 124 read from the IC 521. Therefore, the heating temperature values Th21 to Th24 included in the additive setting data 123a are not heating temperatures themselves, and are values that can be called temperature differences or temperature correction values. The drive control portion 156 adds Th21 to Th24 to the temperature data included in the read data 124 to correct so-called temperature data depending on the type of the raw material MA, and to set a heating temperature depending on the type of the raw material MA. As a specific example, the values of Th21 to Th24 of the additive setting data 123a can be set to +5° C., +10° C., +20° C., ±0° C., respectively.

In this example, when the temperature data read from the IC 521 of the No. 1 additive cartridge 501 is 150° C., the heating temperature of the PPC sheet (printing ratio of less than 20%) is 155° C. by adding 5° C. to 150° C. In addition, the heating temperature of the PPC sheet (printing ratio of 20% or more) is 160° C. by adding 10° C. to 150° C. The heating temperature of the resin-containing recycled sheet is 170° C. by adding 20° C. to 150° C., and the heating temperature of Kraft sheet is 150° C. The values of Th21 to Th24 of the additive setting data 123a may be negative values. By using the additive setting data 123a, the control portion 150 can set the heating temperature depending on the type of the raw material MA based on the temperature data read from the IC 521, that is, the heating temperature suitable for the additive.

FIG. 15 illustrates a treatment of setting operation conditions based on the additive setting data 123a.

The control portion 150 specifies the type of the raw material MA used for manufacturing the sheet S, based on the operation content acquired in Step ST14 (Step ST41). The type of the raw material MA is specified based on the operation of the raw material setting portion 163c of the sheet setting portion 163, for example. The control portion 150 specifies the additive cartridge 501 to be used among the additive cartridges 501 attached to the additive supply portion 52 (Step ST42). The additive cartridge 501 is specified based on the operation of the color setting portion 163a of the sheet setting portion 163, for example. Here, the control portion 150 may specify the amount of additive per unit time supplied from the specified additive cartridge 501.

The control portion 150 refers to the read data 124, and acquires temperature data read from the IC 521 attached on the additive cartridge 501 specified in Step ST42 (Step ST43).

The control portion 150 determines the heating temperature of the heating portion 84 with reference to the additive setting data 123a based on the type of the raw material MA specified in Step ST41 and the additive cartridge 501 specified in Step ST42 (Step ST 44). That is, the control portion 150 acquires, in the additive setting data 123a, the heating temperature set depending on the type of the additive cartridge 501 and the raw material MA to be used. The control portion 150 determines the heating temperature based on the heating temperature acquired from the additive setting data 123a and the temperature data acquired in Step ST43.

The control portion 150 sets the additive cartridge 501 specified in Step ST42, the addition amount of the additive from the additive cartridge 501, and the heating temperature determined in Step ST44 as the operation condition of the manufacturing portion 102 (Step ST45). The set operation conditions are stored in the storage portion 140, for example.

[2] Second Treatment

The second treatment is a treatment of setting the additive cartridge 501 depending on the type of the raw material MA when the heating temperature is constant. For example, examples of the case where the heating temperature is constant include the case where the change of the heating temperature is not easy according to the specification of the heating portion 84, the case where the settable heating temperature range is narrow, and the like.

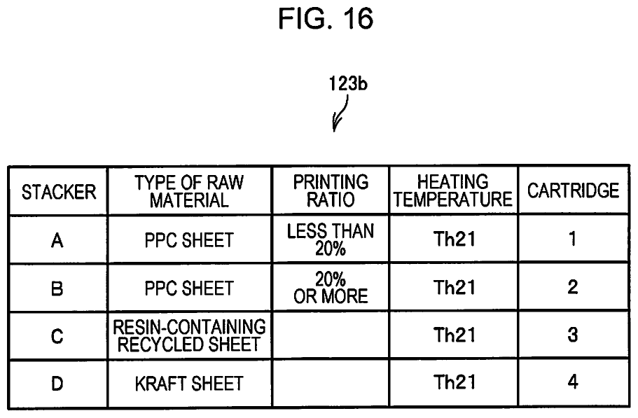

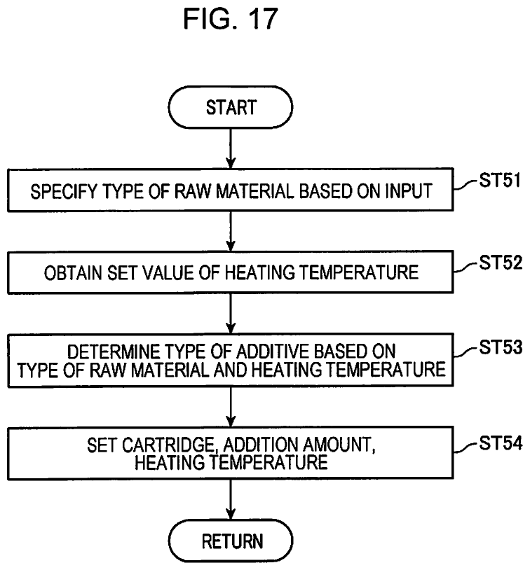

FIG. 16 is a schematic view illustrating a configuration example of the additive setting data 123b as an example of the additive setting data 123. In addition, FIG. 17 is a flowchart illustrating the operation of the sheet manufacturing apparatus 100, and illustrates the second treatment performed in Step ST15.

The additive setting data 123b illustrated in FIG. 16 includes information indicating the type (sheet type) of the raw material MA, the printing ratio, the heating temperature of the heating portion 84, and the additive cartridge 501 to be used, corresponding to each of the stackers 11 provided in the supply portion 10. The information indicating the additive cartridge 501 may be identification information of the IC 521.

The additive setting data 123b of FIG. 16 is used when the heating temperature of the heating portion 84 is common to the four types of raw materials MA. The additive setting data 123b sets the additive cartridge 501 to be used for each of the PPC sheet having a printing ratio of less than 20%, the PPC sheet having a printing ratio of 20% or more, the recycled sheet containing resin, and the Kraft sheet. Since the heating temperature is set to the common temperature Th27, the additive cartridge 501 is selected so as to satisfy the amount of heat required for the melt bonding for each type of the raw material MA.

In the second treatment, any of the additive cartridges 501 is selected from the plurality of additive cartridges 501 containing the additives of the same color. For example, the case where the plurality of additive cartridges 501 containing the additive of the same color are attached to the additive supply portion 52 is mentioned. In addition, the control portion 150 may select any of the plurality of additive cartridges 501 including the additive cartridge 501 not attached to the additive supply portion 52 in the second treatment. In this case, the notification portion 164 or the like may guide the user to replace the additive cartridge 501.

In the example of FIG. 16, one additive cartridge 501 is set depending on the type of the raw material MA.

The setting value Th27 of the heating temperature included in the additive setting data 123b may be a temperature difference with respect to temperature data included in the read data 124 or a correction value of the temperature, and here, the setting value Th27 is a fixed value depending on the type of the raw material MA and the specification of the heating portion 84.

FIG. 17 illustrates a treatment of setting operation conditions based on the additive setting data 123b.

The control portion 150 specifies the type of the raw material MA used for manufacturing the sheet S based on the operation content acquired in Step ST14, similar to Step ST41 (Step ST51). The control portion 150 refers to the additive setting data 123b to obtain the set value of the heating temperature (Step ST52).

The control portion 150 determines the additive cartridge 501 to be used according to the additive setting data 123b based on the type of the raw material MA specified in Step ST51 and the heating temperature specified in Step ST52 (Step ST53). Specifically, the control portion 150 selects one additive cartridge 501 corresponding to the set value of the heating temperature and the type of the raw material MA.

The control portion 150 sets the additive cartridge 501, the additive amount of the additive from the additive cartridge 501, and the heating temperature as the operation condition of the manufacturing portion 102 (Step ST54). The set operation conditions are stored in the storage portion 140, for example.

[3] Third Treatment

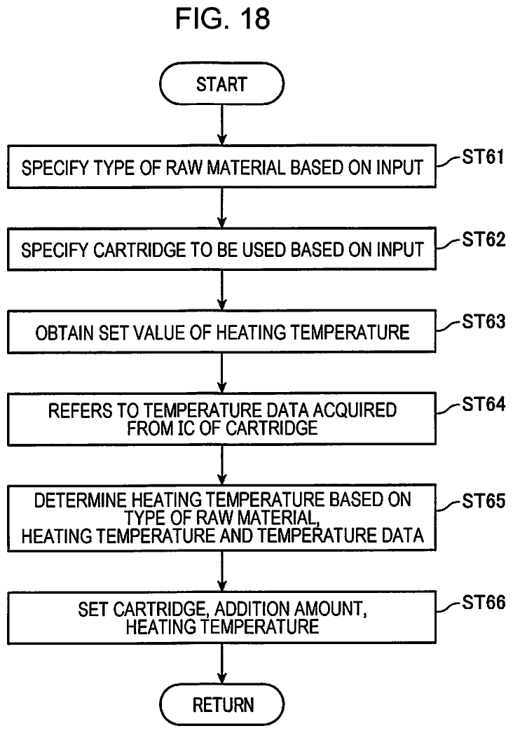

FIG. 18 is a flowchart illustrating the operation of the sheet manufacturing apparatus 100, and illustrates a third treatment performed in Step ST15.

The third treatment is a treatment combining the first treatment and the second treatment. In the third treatment, a reference value of the heating temperature of the sheet manufacturing apparatus 100 or an allowable temperature range is set. The control portion 150 sets the operation conditions in accordance with the type of the raw material MA such that the heating temperature is in the vicinity of or within the temperature range of the reference value.

That is, the control portion 150 specifies the type of the raw material MA used for manufacturing the sheet S based on the operation content acquired in Step ST14 (Step ST61). The control portion 150 specifies the additive cartridge 501 to be used among the additive cartridges 501 attached to the additive supply portion 52 (Step ST62). The additive cartridge 501 is specified based on the operation of the color setting portion 163a of the sheet setting portion 163, for example. Here, the control portion 150 may specify the amount of additive per unit time supplied from the specified additive cartridge 501.

The control portion 150 acquires the setting value of the heating temperature set in the additive setting data 123 (Step ST63). The setting value acquired in Step ST63 is a reference temperature of the heating temperature or an allowable temperature range.

The control portion 150 refers to the read data 124, and acquires temperature data read from the IC 521 of the additive cartridge 501 specified in Step ST62 (Step ST64).

The control portion 150 determines the heating temperature of the heating portion 84 based on the type of the raw material MA, the set value of the heating temperature, and the temperature data acquired in Step ST64 (Step ST65). In Step ST65, the control portion 150 determines the combination of the heating temperature and the additive cartridge 501 corresponding to the raw material MA in the additive setting data 123.

The control portion 150 sets the additive cartridge 501, the additive amount of the additive, and the heating temperature as the operation condition of the manufacturing portion 102 (Step ST66). The set operation conditions are stored in the storage portion 140, for example.

In Step ST15, control portion 150 performs one of the first to third treatments. The control portion 150 may be configured to be able to select one of the first to third treatments. In this case, the control portion 150 selects the treatment to be performed according to the operation on the operation screen 160 or the presetting, and performs the selected treatment in Step ST15. In addition, the control portion 150 may be configured to be able to perform only one or two of the first to third treatments.

Returning to FIG. 12, the control portion 150 performs an activation sequence (Step ST16). In the activation sequence, the control portion 150 performs a treatment for initializing various sensors coupled to the sensor I/F 114 and starting detection. In addition, the activation sequence includes initialization of the operation of each drive portion coupled to the drive portion I/F 115 and control for shifting each drive portion to a state where the manufacture of the sheet S can be started. In this activation sequence, the control portion 150 turns on the power of the heater 339 to start the temperature rise. In addition, the control portion 150 turns on the power of the humidifying heater 345 to start the temperature rise.

The control portion 150 determines whether or not the temperature of the heater 339 is reached the heating temperature set in Step ST14 which is the target temperature (Step ST17), and stands by while the target temperature is not reached (Step ST17; No). As a matter of course, in the standby mode, the control portion 150 can control other drive portions.

When it is determined that the target temperature is reached (Step ST17; Yes), the control portion 150 starts the manufacture of the sheet S, that is, a job by the sheet manufacturing apparatus 100 (Step ST18).

After the manufacture of the sheet S is started, the control portion 150 detects an input that causes a change in the operation condition of the manufacturing portion 102 by an operation on the operation screen 160 (Step ST19). Specifically, the control portion 150 detects the input of the change of the type of the sheet S on the operation screen 160. When there is no such input (Step ST19; No), the control portion 150 determines whether or not the job is completed (Step ST20). For example, when the number of sheets S to be manufactured is specified in Step ST14 and the manufacture of the specified number of sheets S is completed, the job is completed. When the stop instruction button 161b is operated, the job is completed.

When the job is not completed (Step ST20; No), the control portion 150 returns to Step ST19. When the job is completed (Step ST20; Yes), the control portion 150 performs a stop sequence to shift the sheet manufacturing apparatus 100 to a stopped state (Step ST21). In the stop sequence, each drive portion of the manufacturing portion 102 is stopped.

The stop sequence performed in Step ST21 can be performed as an interrupt treatment when the operation of the stop instruction button 161b is performed.

In addition, when an input for the type of sheet S is detected by the operation of the sheet setting portion 163 while the job is performed (Step ST19; Yes), the control portion 150 changes the operation condition of the manufacturing portion 102. (Step ST22).

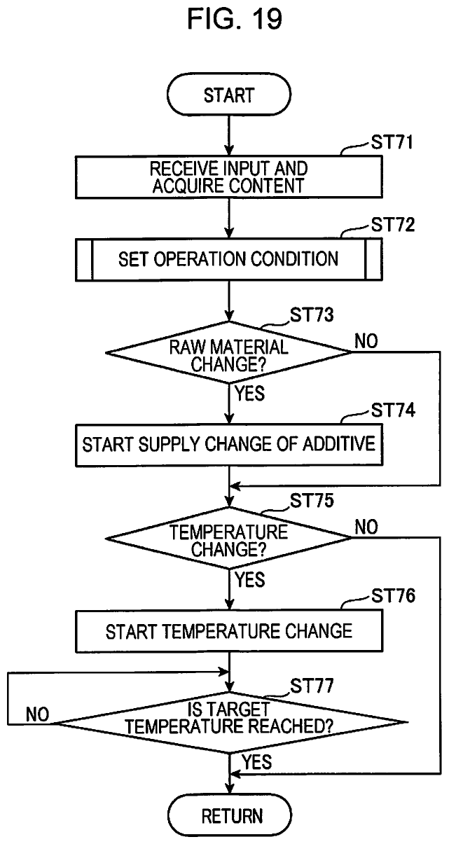

A condition change treatment performed in Step ST22 is illustrated in detail in FIG. 19.

The operation detection portion 153 performs a treatment of receiving an input by a user operation, and acquires an operation content (Step ST71).

The control portion 150 sets an operation condition based on the operation content acquired by the operation detection portion 153 in Step ST71 (Step ST72). This treatment is the same as that in Step ST15. Therefore, while manufacturing the sheet S, the sheet manufacturing apparatus 100 can change the operation condition by receiving the input for changing the type of the raw material MA.

The control portion 150 determines whether or not the setting regarding at least one of raw material MA and the additive is changed in the treatment of Step ST72 (Step ST73). In Step ST72, the control portion 150 determines whether or not the setting added is changed such that the additive added by the additive supply portion 52 and the raw material MA supplied from the supply portion 10 are changed.

When the setting regarding at least one of the raw material MA and the additive is changed (Step ST73; Yes), the control portion 150 causes the additive supply portion 52 to supply the additive so as to correspond to the changed operation condition (Step ST74), and proceeds to Step ST75. When the setting regarding at least one of the raw material MA and the additive is not changed in Step ST72 (Step ST74; No), the control portion 150 proceeds to Step ST75.

In step ST75, the control portion 150 determines whether or not the setting regarding the heating temperature of the heating portion 84 is changed in step ST72 (Step ST75). When the setting related to the heating temperature is changed (Step ST75; Yes), the control portion 150 controls the heater 339 to start changing the temperature of the heating roller 86 (Step ST76). The control portion 150 determines whether or not the temperature of the heater 339 is reached the target temperature (Step ST77), and stands by until the heating temperature is reached (Step ST77; No). As a matter of course, in the standby mode, the control portion 150 can control other drive portions.

When the temperature of the heater 339 is reached the target temperature (Step ST77; Yes), the control portion 150 returns to FIG. 12. On the other hand, when the setting regarding the heating temperature of the heating portion 84 is not changed by Step ST72 (Step ST75; No), the control portion 150 returns to FIG. 12.

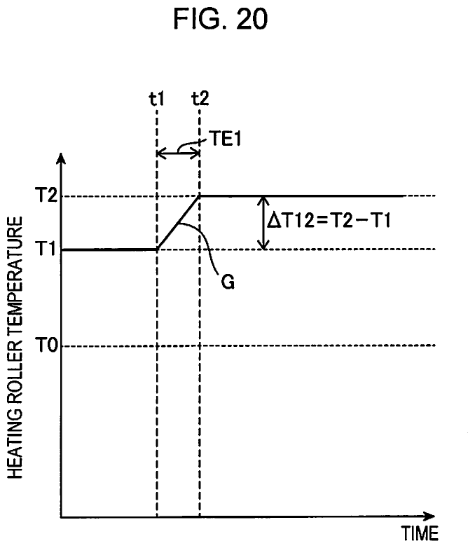

FIG. 20 is a timing chart illustrating an operation example of the sheet manufacturing apparatus 100, and in particular, illustrates a change in temperature of the heating roller 86. A vertical axis in FIG. 20 illustrates the temperature of the heating roller 86. This temperature is a temperature detected by the temperature sensor 309, for example. A horizontal axis illustrates the passage of time.

The temperature T1 in the vertical axis is a temperature suitable for manufacturing the sheet S, and is a target temperature set by the heating control portion 157 in accordance with the conditions of the sheet S to be manufactured. The temperature T2 is a target temperature that is newly set corresponding to the changed operation condition when the operation condition is changed. On the other hand, the temperature T0 indicates the ambient temperature of the place where the sheet manufacturing apparatus 100 is installed, and is a standard of the temperature of the heating roller 86 in a state where the sheet manufacturing apparatus 100 is stopped. That is, the temperature of the heating roller 86 in the state where the sheet manufacturing apparatus 100 is stopped is indicated as the temperature T0.

In the timing chart of FIG. 20, a temperature pattern G illustrates the temperature change of the heating roller 86 when the heating temperature is changed from the temperature T1 to the temperature T2 higher than the temperature T1 under the control of the heating control portion 157. Time t1 is a timing when the control portion 150 starts the temperature rise of the heating roller 86. For example, the timing is a timing at which the condition input by the operation of the sheet setting portion 163 is determined, and corresponds to a timing at which the updated operation condition is determined when the operation condition is set (updated) in Step ST72.

Time t2 is a timing when the temperature of the heating roller 86 reaches the temperature T2. Therefore, a period TE1 from time t1 to time t2 is a time required to realize the set condition.

The control portion 150 may perform control to temporarily suspend the manufacture of the sheet S by the sheet manufacturing apparatus 100 in the period TE1.

In addition, in the period TE1, the control portion 150 may set the operation state of the sheet manufacturing apparatus 100 to an operation state different from the state where the sheet S is manufactured.

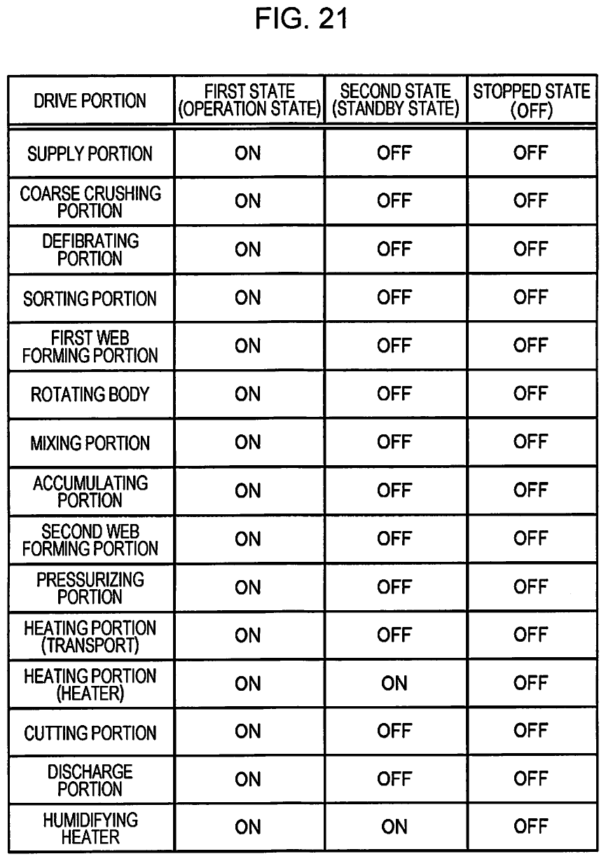

FIG. 21 is a table illustrating an example of the operation state of the sheet manufacturing apparatus 100.

In the drawing, the supply portion refers to the supply portion 10, and refers to the state of the sheet feeding motor 315, for example. The coarse crushing portion refers to the coarse crushing portion 12, and refers to the state of the coarse crushing portion drive motor 311 for example. Although the defibrating portion refers to the defibrating portion 20, and specifically refers to the state of the defibrating portion drive motor 313, the defibrating portion may be in the operation state of the defibrating portion 20 including the state of the defibrating portion blower 26. The sorting portion refers to the sorting portion 40, and specifically refers to the state of the drum drive motor. Although the first web forming portion refers to the first web forming portion 45, and specifically refers to the state of the belt drive motor 327, and the first web forming portion may be in the operation state of the first web forming portion 45 including the state of the collection blower 28. The rotating body refers to the rotational state of the dividing portion drive motor 329 that drives the rotating body 49.

The mixing portion refers to the state of the mixing portion 50, and specifically refers to the operation state of the additive supply motor 317 that drives the additive supply portion 52 and the mixing blower 56. The accumulating portion refers to the accumulating portion 60, and specifically, refers to the operation state of the drum drive motor 331 that moves the drum portion 61. Although the second web forming portion refers to the second web forming portion 70, and specifically refers to the operation state of the belt drive motor 333, the second web forming portion may be in the operation state of the second web forming portion 70 including the state of the suction blower 77. Although the pressurizing portion indicates the pressurizing portion 82, and specifically, the operation state of the pressurizing portion drive motor 335, the pressurizing portion may include the state of the load by the pressurizing portion 82. The heating portion refers to the heating portion 84, and specifically refers to the operation state of the heating portion drive motor 337 and the state of the heater 339, respectively. In addition, although the cutting portion in the drawing refers to the cutting portion 90, and specifically, the operation state of the cutting portion drive motor 351, the cutting portion may include the operation state of the transport portion (not illustrated) transporting the sheet S in the cutting portion 90. The discharge portion refers to the operation state of the transport portion (not illustrated) transporting the sheet S to the discharge portion 96. In addition, the humidifying heater refers to the state of the humidifying heater 345.

In addition, FIG. 21 is not limited to an energized state of each of the drive portions, and indicates the state of control in which the control portion 150 drives each part. For example, ON/OFF of the heating of the heating portion 84 does not indicate ON/OFF of energization of the heater 339, and indicates whether or not the control portion 150 performs control for heating by the heater 339. Therefore, even when there is an instant when the heater 339 is not energized, the operation state is ON while the control portion 150 performs control for heating by the heater 339. The same applies to the other drive portions.

There are three operation states of the sheet manufacturing apparatus 100 according to the present embodiment: a first state, a second state, and a third state. The first state is a state where the sheet manufacturing apparatus 100 manufactures the sheet S, and corresponds to an operation state. In addition, the first state can also be called a normal state. In the first state, as illustrated in FIG. 21, each part of the sheet manufacturing apparatus 100 is ON and driven.

On the other hand, the second state (suspended state) corresponds to the above-described standby state, and is performed under the control of the control portion 150.

The control portion 150 causes the sheet manufacturing apparatus 100 to shift to the second state when the heating temperature of the heating roller 86 is changed, and when the heating temperature after change is reached, that is, in the period TE1. In the second state, at least the drive portion related to the transport of the raw material MA, the material, and the sheet S is turned off. In addition, in the second state, at least the heater 339 is turned on, and more preferably the humidifying heater 345 is turned on.

As a result, while the temperature of the heating roller 86 reaches the target temperature, the transport can be stopped to save energy consumption.

The control portion 150 may perform control to shift the operation state of the sheet manufacturing apparatus 100 to the second state other than the period Tn. For example, when the standby instruction button 161d is operated on the operation screen 160, the control portion 150 may cause the sheet manufacturing apparatus 100 to shift from the first state to the second state.

As illustrated in FIG. 21, in the stopped state, each drive portion (including heater 339 and humidifying heater 345) coupled to the drive portion I/F 115 is turned off.

Returning to FIG. 12, after changing the operation conditions in Step ST22, the control portion 150 performs the manufacture of the sheet S (Step ST23), and proceeds to Step ST20.

In the example illustrated in FIG. 20, although the case where the heating temperature of the heating roller 86 is raised from the temperature T1 to the temperature T2 is illustrated, once the heating temperature of the heating roller 86 is lower than the temperature T1, the sheet manufacturing apparatus 100 may be stood by.

For example, the type of additive may be changed in Step ST72, and it may take time to change the additive. Specifically, the additive cartridge 501 attached to the sheet manufacturing apparatus 100 may be replaced in order to change the additive. In such a case, the control portion 150 needs to stop the manufacture of the sheet S by the sheet manufacturing apparatus 100 until the operation of replacing the additive cartridge 501 is completed. In the present embodiment, the control portion 150 stands by the sheet manufacturing apparatus 100 in the second state, and returns to the first state after the replacement of the additive cartridge 501 is completed. While standing by in the second state, the heating temperature of the heating roller 86 is once maintained at a temperature lower than any of the temperatures T1 and T2.

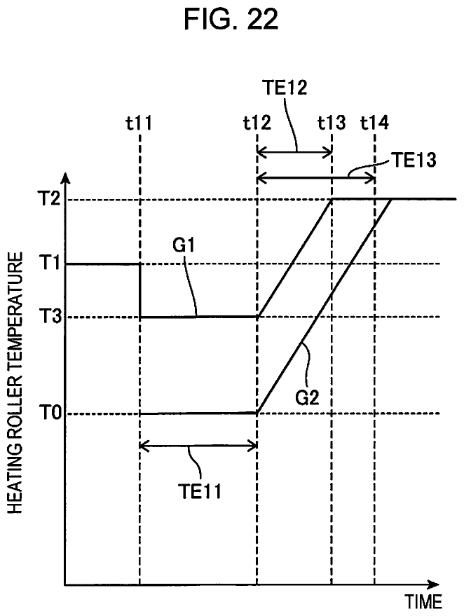

FIG. 22 is a timing chart illustrating an operation example of the sheet manufacturing apparatus 100, and in particular, illustrates a change in temperature of the heating roller 86. Similarly to FIG. 20, the vertical axis in FIG. 22 indicates the temperature of the heating roller 86, and the temperatures T1, T2 and T0 in the vertical axis are the same as these in FIG. 20.

The temperature T3 is a temperature set by the heating control portion 157 as a target temperature during standby. The temperature T3 is lower than the temperatures T1 and T2. For example, the control portion 150 sets a temperature that is lower by a predetermined temperature difference T* (for example, 10° C.) as the temperature T3 as compared with any one of the temperature T1 and the temperature T2 that is lower. In addition, the control portion 150 may set a preset temperature as the temperature T3. For example, the setting value of the temperature T3 or the setting value of the temperature T* is included in the setting data 121 and stored in the storage portion 140.

In the timing chart of FIG. 22, as illustrated by the temperature pattern G1, the temperature of the heating roller 86 is maintained at T1 in the first state. When the transition to the second state is started at time t11, the control portion 150 sets the target temperature to the temperature T3, so the temperature of the heating roller 86 decreases. Thereafter, under the control of the heating control portion 157, the temperature of the heating roller 86 is maintained at the temperature T3 in the second state.

When the transition to the first state is started at time t12, the temperature rise of the heating roller 86 is started. At a timing (time t13) at which the temperature of the heating roller 86 reaches T2, the drive control portion 156 starts the operation of the drive portion related to the transport of the raw material MA, the material, and the sheet S, the sheet manufacturing apparatus 100 is shifted to the first state, and the manufacturing of the sheet S is started.

In the temperature pattern G1, the waiting time from when the change of the additive is completed to when the sheet manufacturing apparatus 100 starts manufacturing the sheet S corresponds to a period TE12 from time t12 to time t13.

The temperature pattern G2 illustrates, as a comparative example, an example in which the temperature of the heating roller 86 is raised to the temperature T2 from a state where the sheet manufacturing apparatus 100 is stopped. In the stopped state, the temperature of the heating roller 86 is close to the ambient temperature T0. When the transition to the first state is started at time t12, and the heating roller 86 is heated from the temperature T0, the temperature of the heating roller 86 reaches the temperature T2 as the target temperature at time t14. In the temperature patterns G1 and G2, since the configuration of the heating portion 84 including the heater 339 is common, the temperature rise pattern, that is, the slope of the temperature rise is substantially the same as each other. Therefore, in the temperature pattern G2, the temperature of the heating roller 86 rises with the same inclination as time t12 to t13 of the temperature pattern G1, and the Time t14 when the temperature of the heating roller 86 reaches the target temperature T2 is later than time t13. In the temperature pattern G1, the waiting time from the start of the temperature rise of the heating roller 86 to the start of the manufacture of the sheet S corresponds to the period TE12, and the waiting time in the temperature pattern G2 corresponds to the period TE13. It is clear that the period TE13 is longer than the period TE12.

That is, it is necessary to stop the manufacture of the sheet S by the sheet manufacturing apparatus 100 and cause the manufacture to stand by, such as change of the additive. When the standing by time is long, the manufacture of the sheet S can be rapidly started by causing the sheet manufacturing apparatus 100 to stand by in the second state.

As illustrated in FIG. 22, the sheet manufacturing apparatus 100 may be configured to be capable of performing the first state where each drive portion coupled to the drive portion I/F 115 under the control of the control portion 150 operates, and the second state, in addition to the stopped state where each drive portion stops. In the second state, the operation state of a portion of the sheet manufacturing apparatus 100, for example, the heater 339 and the humidifying heater 345, is maintained ON, and for example, the temperature of the heating roller 86 can be maintained higher than the ambient temperature. Therefore, when the manufacture of the sheet S is started from the second state, the manufacture of the sheet S can be performed in a shorter time, as compared with when the manufacture of the sheet S is started from the stopped state, and the waiting time can be reduced.

In addition, in the second state, by maintaining the humidifying heater 345 ON, the temperature of the vaporization type humidifier 343 can be maintained higher than the air temperature (ambient temperature) of the installation place of the sheet manufacturing apparatus 100. Therefore, when the manufacture of the sheet S is not started until the temperature of the vaporization type humidifier 343 rises to a preferable temperature, similar to the contents described for the heater 339, the waiting time until the manufacture start of the sheet S can be reduced.

In addition, the control portion 150 stops the drive portion other than the heater 339 and the humidifying heater 345, more specifically, the drive portion that transports the material and the sheet S until the heating roller 86 reaches the temperature T2. Therefore, the sheet S is not manufactured until the temperature of the heating roller 86 changes corresponding to the change of the raw material MA and the material. As a result, the material which has a heating defect in the heating portion 84 can be reduced.

As described above, the sheet manufacturing apparatus 100 according to the first embodiment is provided with the defibrating portion 20 that defibriates the raw material MA, and the mixing portion 50 that mixes the defibrated material defibriated by the defibrating portion 20 and the additive. The sheet manufacturing apparatus 100 includes the heating portion 84 that heats the mixture mixed by the mixing portion 50, and the control portion 150 that controls the temperature of the heating portion 84. The control portion 150 sets the heating temperature of the heating portion 84 to a temperature depending on the type of the raw material MA defibrated by the defibrating portion 20.

According to the sheet manufacturing apparatus of the present invention and the sheet manufacturing apparatus 100 to which the control method of the sheet manufacturing apparatus is applied, the heating temperature when the raw material MA is defibrated and the defibrated material and the additive are mixed and heated is set to a temperature depending on the type of the raw material MA. As a result, the heating temperature can be appropriately set as a condition for manufacturing the sheet in the sheet manufacturing apparatus 100, and a high quality sheet can be manufactured.

In addition, the sheet manufacturing apparatus 100 is provided with the additive supply portion 52 that individually contains different types of the additives and supplies the additive to the mixing portion 50. The control portion 150 selects at least one type of additive from a plurality of types of the additives depending on the type of the raw material MA defibrated by the defibrating portion 20, and the selected additive is supplied by the additive supply portion 52. As a result, since it is possible to select and use the additive suitable for the raw material MA from different types of the additives, a higher quality sheet can be manufactured.

In addition, the sheet manufacturing apparatus 100 includes the defibrating portion 20 that defibrates the raw material MA, and the additive supply portion 52 that individually contains different types of the additive and supplies the additive. The sheet manufacturing apparatus 100 includes the mixing portion 50 for mixing the defibrated material defibrated by the defibrating portion 20 and the additive supplied from the additive supply portion 52, and the heating portion 84 that heats the mixture mixed by the mixing portion 50. In addition, the sheet manufacturing apparatus 100 includes the control portion 150 which selects the additive to be supplied to the mixing portion 50 and causes the additive supply portion 52 to supply the selected additive. The control portion 150 selects at least one type of additive from a plurality of types of the additives depending on the type of the raw material MA defibrated by the defibrating portion 20 and causes the additive supply portion 52 to supply the selected additive.

According to the sheet manufacturing apparatus of the present invention and the sheet manufacturing apparatus 100 to which the control method of the sheet manufacturing apparatus is applied, when the sheet is manufactured by the raw material MA is defibrated, and the defibrated material and the additive are mixed and heated, the additive suitable for the raw material MA can be selected and used.

As a result, the type of additive can be appropriately set as a condition for manufacturing the sheet in the sheet manufacturing apparatus 100, and a high quality sheet can be manufactured.

In addition, the control portion 150 selects at least one type of additive from the plurality of types of the additives based on the type of the raw material MA defibrated by the defibrating portion 20 and the heating temperature of the heating portion 84. As a result, the heating temperature can be set to an appropriate temperature depending on the type of the raw material MA and the additive, and a high quality sheet can be manufactured.

In addition, the control portion 150 changes the temperature of the heating portion 84 depending on the type of the raw material MA defibrated by the defibrating portion 20. As a result, the heating temperature can be set to an appropriate temperature depending on the type of the raw material MA, and a high quality sheet can be manufactured.

In addition, the sheet manufacturing apparatus 100 includes the plurality of additive cartridges 501 containing different types of the additives, and the additive supply portion 52 supplies the additive from any one or more of the additive cartridges 501 under the control of the control portion 150. The control portion 150 sets one or more additive cartridges 501 to be used among the plurality of additive cartridges 501. The control portion 150 acquires heating temperature information from the set IC 521 of the additive cartridge 501, and sets the temperature of the heating portion 84 based on the acquired heating temperature information. As a result, a sheet can be manufactured using the additive depending on the type of sheet to be manufactured, and the heating temperature suitable for the additive can be set, so that a high quality sheet can be manufactured.

In addition, the sheet manufacturing apparatus 100 is provided with the touch sensor 117 and the operation detection portion 153 that receive an input related to the type of the raw material MA. The control portion 150 sets the type of raw material MA in response to the input received by the touch sensor 117 and the operation detection portion 153. As a result, the type of the raw material MA is set in response to the input, and the sheet can be manufactured under the conditions suitable for the set raw material MA, and a high quality sheet can be manufactured.

In addition, the control portion 150 changes the type of the raw material MA in response to the input received by the touch sensor 117 and the operation detection portion 153 in a state where the sheet manufacturing apparatus 100 manufactures the sheet. As a result, the type of the raw material MA can be changed in response to the input in the state where the sheet is manufactured.

In addition, the sheet manufacturing apparatus 100 is provided with the separating portion 10a that separates the raw material MA for each type, and the supply portion 10 that supplies the raw material MA separated by the separating portion 10a for each type. The defibrating portion 20 defibrates the raw material MA supplied from the supply portion 10. As a result, since the raw material MA for each type can be separated and supplied, a sheet under conditions suitable for the raw material MA can be manufactured.

Incidentally, in the sheet manufacturing apparatus 100, it may take time until the quality of the sheet S is stable after the manufacturing start (job start) of the sheet S. Since the sheet S manufactured during this time may not reach the desired quality, it is recommended that the sheet S is returned from the discharge portion 96 to the supply portion 10 to be used as the raw material MA. When the conditions related to the manufacture of the sheet S are changed, although insufficient heating of the heating roller 86 may occur, stopping the transport of the material and the sheet S while the heating roller 86 is heated can reduce the sheet S insufficiently heated. As a result, the amount of sheets S returned to the raw material MA can be reduced.

When the type of additive used and the amount and ratio of each additive are changed by changing the conditions for manufacturing the sheet S, it takes time until the material to which the additive is added based on the changed conditions is discharged to the discharge portion 96 as the sheet S. For example, when the amount and type of the additive added in the additive supply portion 52 are changed, it takes a time until the changed material reaches the heating portion 84 corresponding to a length until the material is transported from the additive supply portion 52 to the heating portion 84. That is, a material present between the additive supply portion 52 and the heating portion 84 at time t13 (mixture of subdivision P and additive, and second web W2, which is referred to as remaining material) is a material in which the additive is mixed under the condition before the operation condition is changed.

The remaining material is heated at a temperature T2 corresponding to the changed operation conditions, so that the remaining material is heated at a temperature different from that suitable for the material. Therefore, the control portion 150 may perform an operation of discharging the sheet S including the amount of remaining material to a position different from the sheet S in a preferable state (non-defective product), or an operation of returning the sheet S including the amount of remaining material from the discharge portion 96 to the supply portion 10 in the discharge portion 96. Alternatively, the notification portion 164 may notify at a timing when the non-defective sheet S is discharged to the discharge portion 96 after all the sheets S including the amount of remaining material are discharged to the discharge portion 96. For example, the control portion 150 may count the length of the sheet S discharged from the discharge portion 96, and may determine that the discharge of the sheet S including the amount of remaining materials is completed when the length of the sheet S discharged after time t13 exceeds the distance between the additive supply portion 52 and the discharge portion 96.

### Second Embodiment

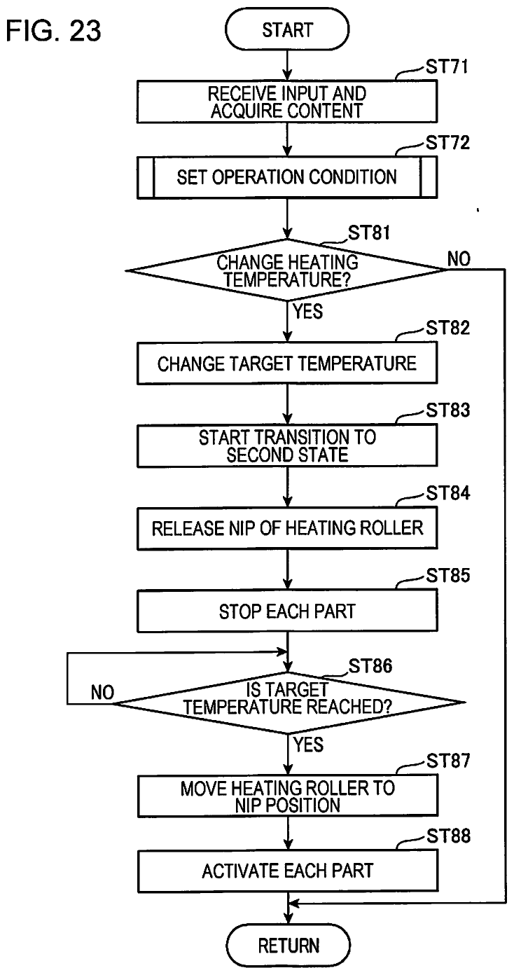

FIG. 23 is a flowchart illustrating the operation of the sheet manufacturing apparatus 100 according to the second embodiment to which the present invention is applied. The sheet manufacturing apparatus 100 according to the second embodiment has the same configuration as the sheet manufacturing apparatus 100 described in the first embodiment, and thus the illustration and the description thereof will not be repeated.

In the second embodiment, the sheet manufacturing apparatus 100 performs the operation of FIG. 23 instead of the operation illustrated in FIG. 19. That is, when the condition of the sheet S is changed by the operation of the operation screen 160, the operation of FIG. 23 is performed by interrupt control. In the following description, the same step numbers are given to steps common to the operations of FIG. 19.

The operations illustrated in FIG. 23 are examples of performing operations of releasing the nip of the heating roller 86 in the process of raising the temperature of the heating roller 86 when the heating temperature is changed among the operation conditions in Step ST72. In the second embodiment, for the convenience of description, although the operation corresponding to the change of the heating temperature is illustrated in Step ST72, it is of course possible to perform the operation corresponding to the change when the setting regarding the additive is changed in Step ST72.

The operation detection portion 153 performs a treatment of receiving an input by a user operation, and acquires an operation content (Step ST71).

The control portion 150 sets an operation condition based on the operation content acquired by the operation detection portion 153 in Step ST71 (Step ST72).

The control portion 150 determines whether or not the setting regarding the heating temperature of the heating portion 84 is changed in the treatment of Step ST72 (Step ST81). When the setting regarding the heating temperature is changed (Step ST81; Yes), the control portion 150 changes the target temperature according to the setting after the change (Step ST82), whereby the temperature of the heating roller 86 is raised in accordance with the target temperature after the change.

Here, the control portion 150 starts the transition to the second state (Step ST83). The control portion 150 operates the roller moving portion 341 to release the nip of heating roller 86 (Step ST84). Specifically, the first rotating body 181 (FIGS. 3 and 4) and the second rotating body 182 (FIGS. 3 and 4) are moved from the first position illustrated in FIG. 3 to the second position illustrated in FIG. 4.

Thereafter, the control portion 150 stops each part of the sheet manufacturing apparatus 100 according to the second state illustrated in FIG. 21 (Step ST85).

The control portion 150 determines whether or not the temperature of the heater 339 is reached the target temperature (Step ST86), and stands by until the heating temperature is reached (Step ST86; No). As a matter of course, in the standby mode, the control portion 150 can control other drive portions.

When the temperature of the heater 339 is reached the target temperature (Step ST86; Yes), the control portion 150 operates the roller moving portion 341 to nip the heating roller 86 (Step ST87). Specifically, the first rotating body 181 and the second rotating body 182 are moved from the second position illustrated in FIG. 4 to the first position illustrated in FIG. 3.

Thereafter, the control portion 150 shifts each part of the sheet manufacturing apparatus 100 to the first state, and returns to the operation of FIG. 12. In addition, when it is determined in Step ST81 that the setting regarding the heating temperature is not changed (Step ST81; No), the control portion 150 returns to the operation of FIG. 12.

In the second state, while the transport of the material and the sheet S is stopped to heat the heating roller 86, the second web W2 is in contact with the heating roller 86. Therefore, when the difference between the heating temperature after the change and the heating temperature before the change is large, the second web W2 may be subjected to an excessive heat history to cause excessive melting, which may cause sticking of the second web W2 to the heating roller 86 or discoloration, for example. In addition, from the viewpoint of smoothly raising the temperature of the heating roller 86 and making the surface temperature of the heating roller 86 uniform, the second web W2 is preferably not in contact with the heating roller 86.

As illustrated in FIG. 23, when the nip is released in the process of raising the temperature of the heating roller 86, the contact state of the second web W2 with the heating roller 86 can be released during the temperature rise. As a result, the temperature of the heating roller 86 can be smoothly raised, and the temperature of the surface of the heating roller 86 can be made uniform.

In addition, the heating roller 86 may be rotated after releasing the nip in Step ST84 until the heating roller 86 is nipped in Step ST87. That is, the heating roller 86 may be driven idle. The idle drive has the effect of making the surface temperature of the heating roller 86 more uniform. In particular, as in the heating body 183 illustrated in FIG. 3, the configuration in which the heating roller 86 is heated by an external heating unit is effective.

In addition, when the sheet manufacturing apparatus 100 shifts from the second state to the first state by the control of the drive control portion 156, in a case in which the heating portion 84 is displaced from the second position to the first position, the target temperature may be temporarily changed.

It is known that a decrease in temperature occurs when a pair of heating rollers 86 is nipped. Therefore, in the process of raising the temperature of the heating roller 86 by the heater 339 in the second state, the heating control portion 157 may raise the temperature of the heating roller 86 to a temperature higher than the target temperature T1. More specifically, the heating control portion 157 sets the target temperature set in Step ST82 to a temperature (here, temperature T2′) higher than the target temperature corresponding to the setting in Step ST72. At the timing when the temperature of the heating roller 86 reaches the target temperature T2′, the drive control portion 156 displaces the heating portion 84 to the first position (Step ST 87), and the heating control portion 157 sets the target temperature to a temperature T2 corresponding to the changed operation condition. The temperature T2′ can be obtained by adding a temperature difference ΔT set in advance to the temperature T2 after the temperature T2 is determined. The temperature difference ΔT is determined in consideration of the temperature decrease due to the nip, and may be stored in the setting data 121 in advance, for example.

As a result, even when the sheet manufacturing apparatus 100 is shifted to the first state at the timing when the heating portion 84 is displaced to the first position and the manufacture of the sheet S is rapidly started, the second web W2 can be reliably heated in the heating portion 84, immediately after the start of manufacture. Therefore, the amount of the sheet S which is defective in heating can be reduced.

Similarly, even when the manufacture of the sheet S is started from the stopped state, the heating control portion 157 temporarily sets a temperature higher than the target temperature corresponding to the condition related to the sheet S until the sheet manufacturing apparatus 100 shifts to the first state, and thus the same effect can be obtained.

In the operation of the second embodiment, the sheet manufacturing apparatus 100 and the control method of the sheet manufacturing apparatus of the present invention are applied to the sheet manufacturing apparatus 100, and the same effects as those of the first embodiment can be obtained.

The above-described embodiments are merely specific aspects for performing the present invention described in the aspects, and do not limit the present invention. It is not limited that all of the configurations described in the above embodiments are essential constituent requirements of the present invention. In addition, the present invention is not limited to the configuration of the above embodiment, and can be implemented in various aspects without departing from the scope of the invention.

For example, in each of the above-described embodiments, although the configuration is exemplified in which the stacker 11 is provided as the accommodation portion for accommodating the raw material MA for each type, the present invention is not limited thereto. For example, the raw material defibrated by the defibrating portion 20 may be supplied from the outside. In this configuration, a plurality of cartridges (not illustrated) accommodating the defibrated raw materials may be provided, and it is possible to switch from these cartridges and supply the defibrated material as the raw material to the drum portion 41. In addition, the subdivided body P may be supplied to the tube 54 from the outside as the raw material.

In addition, the sheet manufacturing apparatus 100 of each of the above-described embodiments is described as a dry type sheet manufacturing apparatus 100 that manufactures the sheet S by obtaining a material by defibrating the raw material MA in the air to use the material and the resin. The application object of the present invention is not limited thereto, and it can also be applied to a so-called wet type sheet manufacturing apparatus in which a raw material containing fibers is dissolved or suspended in a solvent such as water and this raw material is processed into a sheet. In addition, the present invention can also be applied to an electrostatic type sheet manufacturing apparatus in which a material containing fibers defibrated in the air is adsorbed on the surface of a drum by static electricity or the like, and the raw material adsorbed on the drum is processed into a sheet. In these sheet manufacturing apparatuses, the configuration of the above embodiment can be applied in the step of transporting the sheet-like material before being processed into a sheet. When the sheet manufacturing apparatus has the heating portion heating the raw material, the present invention can be applied to the control portion that controls the temperature of the heating portion.

In addition, the sheet manufacturing apparatus 100 may be configured to manufacture a board-like or web-like product configured to include a hard sheet or a laminated sheet, without being limited to the sheet S. In addition, the sheet S may be a sheet made of pulp or waste sheet as the raw material MA, or may be a non-woven fabric containing fibers made of natural fibers or synthetic resins. In addition, the properties of the sheet S are not particularly limited, and may be a sheet usable as recording sheet (for example, so-called PPC sheet) for writing and printing purposes, or may be a wallpaper, a wrapping paper, a colored paper, a drawing paper, a Kent paper or the like. In addition, when the sheet S is a non-woven fabric, the sheet S may be a fiber board, a tissue paper, a kitchen paper, a cleaner, a filter, a liquid absorber, a sound absorber, a buffer, a mat or the like, in addition to a general non-woven fabric.

### REFERENCE SIGNS LIST

9 chute
10 supply portion (raw material supply portion)
10a separating portion
11 stacker (accommodation portion)
12 coarse crushing portion
20 defibrating portion
26 defibrating portion blower
27 dust collection portion
28 collection blower
40 sorting portion
41 drum portion
45 first web forming portion
46 mesh belt
48 suction portion
49 rotating body
50 mixing portion
52 additive supply portion
52a discharge portion
52b supply adjustment portion
52c supply tube
54 tube
56 mixing blower
60 accumulating portion
61 drum portion
62 introduction port
70 second web forming portion
72 mesh belt
76 suction mechanism
77 suction blower
79 transport portion
79a mesh belt
80 sheet forming portion
82 pressurizing portion
84 heating portion
85 calender roller
86 heating roller
90 cutting portion
92 first cutting portion
94 second cutting portion
96 discharge portion
100 sheet manufacturing apparatus
102 manufacturing portion
110 control device
111 main processor
114 sensor I/F
115 drive portion I/F
116 display panel
117 touch sensor (reception portion)
119 IC reader
120 non-volatile storage portion
121 setting data
122 display data
123 additive setting data
124 read data
140 storage portion
150 control portion
151 operating system
153 operation detection portion (reception portion)
154 detection control portion
155 data acquisition portion
156 drive control portion
157 heating control portion
160 operation screen
161 operation instruction portion
161a start instruction button
161b stop instruction button
161c suspend instruction button
161d standby instruction button
162 cartridge information display portion
162a cartridge image
162b remaining amount gauge
162c cartridge selection portion
163 sheet setting portion
163a color setting portion
163b thickness setting portion
163c raw material setting portion
164 notification portion
181 first rotating body
182 second rotating body
183 heating body
190 displacement mechanism
202, 204, 206, 208, 210, 212 humidifying portion
301 waste sheet remaining amount sensor
302 additive remaining amount sensor
303 sheet discharge sensor
304 water amount sensor
306 air volume sensor
307 air velocity sensor
309 temperature sensor
311 coarse crushing portion drive motor
313 defibrating portion drive motor
315 sheet feeding motor
317 additive supply motor
318 intermediate blower
325 drum drive motor
327 belt drive motor
329 dividing portion drive motor
331 drum drive motor
333 belt drive motor
335 pressurizing portion drive motor
337 heating portion drive motor
339 heater
341 roller moving portion
343 vaporization type humidifier (humidifying portion)
345 mist type humidifier
345 humidifying heater
349 water supply pump
351 cutting portion drive motor
391 color measurement portion
393 scanner
397 raw material distribution portion
501 additive cartridge (cartridge)
521 IC
521a type data
521b temperature data
521c remaining amount data
H heat source
MA raw material
P subdivided body
S sheet
W1 first web
W2 second web

1. A sheet manufacturing apparatus comprising:
a defibrating portion that defibrates a raw material;
a mixing portion that mixes a defibrated material defibrated by the defibrating portion with a binding material;
a heating portion that heats a mixture mixed by the mixing portion; and
a control portion that controls a temperature of the heating portion, wherein
the control portion sets a heating temperature of the heating portion to a temperature depending on a type of the raw material defibrated by the defibrating portion.

2. The sheet manufacturing apparatus according to claim 1, further comprising:
a binding material supply portion that individually contains different types of the binding materials and supplies the binding material to the mixing portion, wherein
the control portion selects at least one type of the binding material from a plurality of types of the binding materials depending on the type of the raw material defibrated by the defibrating portion, and causes the selected binding material to be supplied by the binding material supply portion.

3. A sheet manufacturing apparatus comprising:
a defibrating portion that defibrates a raw material;
a binding material supply portion that individually contains different types of the binding materials and supplies the binding material;
a mixing portion that mixes a defibrated material defibrated by the defibrating portion with the binding material supplied by the binding material supply portion;
a heating portion that heats a mixture mixed by the mixing portion; and
a control portion that selects the binding material to be supplied to the mixing portion and causes the binding material to be supplied by the binding material supply portion, wherein
the control portion selects at least one type of the binding material among a plurality of types of the binding materials depending on a type of the raw material defibrated by the defibrating portion and causes the selected binding material to be supplied by the binding material supply portion.

4. The sheet manufacturing apparatus according to claim 3, wherein
the control portion selects at least one type of the binding material from the plurality of types of the binding materials based on a type of the raw material defibrated by the defibrating portion and a heating temperature of the heating portion.

5. The sheet manufacturing apparatus according to claim 3, wherein
the control portion changes a temperature of the heating portion depending on the type of the raw material defibrated by the defibrating portion.

6. The sheet manufacturing apparatus according to claim 3, further comprising:
a plurality of cartridges that contain different types of the binding materials, wherein
the binding material supply portion supplies the binding material from any one or more of the cartridges under control of the control portion, and
the control portion sets one or more of the cartridges to be used among the plurality of cartridges, acquires heating temperature information from the set cartridge, and sets a temperature of the heating portion based on the acquired heating temperature information.

7. The sheet manufacturing apparatus according to claim 1, further comprising:
a reception portion that receives an input related to the type of the raw material, wherein
the control portion sets the type of the raw material in response to the input received by the reception portion.

8. The sheet manufacturing apparatus according to claim 7, wherein
the control portion changes the type of the raw material in response to the input received by the reception portion in a state where the sheet manufacturing apparatus is manufacturing the sheet.

9. The sheet manufacturing apparatus according to claim 1, further comprising:
a separating portion that separates the raw materials for each type; and
a raw material supply portion that supplies the raw materials separated by the separating portion for each type, wherein
the defibrating portion defibrates the raw material supplied from the raw material supply portion.

10. A control method of a sheet manufacturing apparatus, which uses a raw material and heats a material containing fibers to form a sheet, the method comprising:
setting a heating temperature to a temperature depending on a type of the raw material.

11. A control method of a sheet manufacturing apparatus, comprising:
defibrating a raw material;
mixing a defibrated material with a binding material;
heating a mixed mixture by a heating portion to manufacture a sheet; and
setting a heating temperature of the heating portion to a temperature depending on a type of the raw material to be defibrated.

12. A control method of a sheet manufacturing apparatus, comprising:
defibrating a raw material;
mixing a defibrated material with a binding material selected from different types of the binding materials;
heating a mixed mixture by a heating portion to manufacture a sheet; and
selecting at least one type of the binding material among a plurality of types of the binding materials depending on a type of the raw material.
